(19) United States
(12) Patent Application Publication
(10) Pub. No.: US 2025/0043184 A1
(43) Pub. Date: Feb. 6, 2025

(54) OPTICALLY ANISOTROPIC FILM AND DISPLAY DEVICE

(71) Applicant: FUJIFILM Corporation, Tokyo (JP)

(72) Inventors: Yuki HIRAI, Kanagawa (JP); Mayumi NOJIRI, Kanagawa (JP); Ryoji HIMENO, Kanagawa (JP); Shinichi MORISHIMA, Kanagawa (JP); Ayako MURAMATSU, Kanagawa (JP)

(73) Assignee: FUJIFILM Corporation, Tokyo (JP)

(21) Appl. No.: 18/919,057

(22) Filed: Oct. 17, 2024

Related U.S. Application Data
(63) Continuation of application No. PCT/JP2023/015772, filed on Apr. 20, 2023.

(30) Foreign Application Priority Data
Apr. 28, 2022 (JP) 2022-074318

(51) Int. Cl. C09K 19/44; C09K 19/52; G02B 1/02; G02B 5/20

(52) U.S. Cl. CPC C09K 19/44; G02B 1/02; G02B 5/206; G02B 5/208; C09K 2019/523

(57) ABSTRACT

An optically anisotropic film which is excellent in aligning properties, light resistance, and moisture-heat resistance. The optically anisotropic film contains a liquid crystal compound or a polymer, and an aggregate of organic compounds, in which the optically anisotropic film has no absorption in a visible light region, an average value of ratios of lengths of major axes of the aggregate to lengths of minor axes of the aggregate is 2.0 or more, and an average length of the minor axes of the aggregate is 10 nm or more.

### CROSS-REFERENCE TO RELATED APPLICATIONS

This application is a Continuation of PCT International Application No. PCT/JP2023/015772 filed on Apr. 20, 2023, which was published under PCT Article 21(2) in Japanese, and which claims priority under 35 U.S.C. § 119(a) to Japanese Patent Application No. 2022-074318 filed on Apr. 28, 2022. The above applications are hereby expressly incorporated by reference, in their entirety, into the present application.

### BACKGROUND OF THE INVENTION

### 1. Field of the Invention

The present invention relates to an optically anisotropic film and a display device.

### 2. Description of the Related Art

An optically anisotropic film is used in various applications such as a display device, a camera, and a sensor.

For example, JP2011-519060A discloses an optically anisotropic compensation panel including one or more optically anisotropic layers based on an arranged guest-host system.

### SUMMARY OF THE INVENTION

In recent years, it has been required that an optically anisotropic film has excellent aligning properties, light resistance, and moisture-heat resistance.

The light resistance means that, in a case where the optically anisotropic film is irradiated with light, optical characteristics (for example, an in-plane retardation or the like) of the optically anisotropic film are less likely to change before and after the irradiation with light. In addition, the moisture-heat resistance means that, in a case where the optically anisotropic film is stored at a high temperature and high humidity, optical characteristics (for example, a polarization degree or the like) of the optically anisotropic film are less likely to change before and after the storage.

As a result of studying the optically anisotropic film using the material disclosed in JP2011-519060A, the present inventors have found that the current requirement level has not been satisfied and thus further improvement is necessary.

An object of the present invention is to provide an optically anisotropic film which is excellent in aligning properties, light resistance, and moisture-heat resistance.

Another object of the present invention is to provide a display device.

As a result of intensive studies on the problems in the related art, the present inventors have found that the above-described objects can be accomplished by the following configurations.

[1]

An optically anisotropic film comprising:
a liquid crystal compound or a polymer; and
an aggregate of organic compounds,
in which the optically anisotropic film has no absorption in a visible light region,
an average value of ratios of lengths of major axes of the aggregate to lengths of minor axes of the aggregate is 2.0 or more, and
an average length of the minor axes of the aggregate is 10 nm or more.
   [2]

The optically anisotropic film according to [1],
in which the optically anisotropic film has an absorption in an infrared region.
   [3]

The optically anisotropic film according to [2],
in which a dichroic ratio in the infrared region is 10 or more.
   [4]

The optically anisotropic film according to [2] or [3],
in which an angle between a slow axis of the optically anisotropic film at a wavelength of 550 nm and a direction in which the absorption of the optically anisotropic film at a maximal absorption wavelength in the infrared region is largest is 0° to 10° or 80° to 100°.
   [5]

The optically anisotropic film according to any one of [1] to [4],
in which the aggregate is a J-aggregate.
   [6]

The optically anisotropic film according to [5],
in which, in a case where an absorption spectrum of the aggregate in an infrared region is subjected to waveform separation, the absorption spectrum is composed of a plurality of peaks derived from the J-aggregate.
   [7]

The optically anisotropic film according to any one of [1] to [6],
in which the optically anisotropic film contains the liquid crystal compound, and
the liquid crystal compound is lyotropic liquid crystalline.
   [8]

A display device comprising:
the optically anisotropic film according to any one of [1] to [7].

According to the present invention, it is possible to provide an optically anisotropic film which is excellent in aligning properties, light resistance, and moisture-heat resistance.

In addition, according to the present invention, it is possible to provide a display device.

### BRIEF DESCRIPTION OF THE DRAWINGS

FIG. 1 is an example of an absorption spectrum in a case where an absorption spectrum of an aggregate of organic compounds in an infrared region is subjected to waveform separation.

### DESCRIPTION OF THE PREFERRED EMBODIMENTS

Hereinafter, the present invention will be described in detail.

In the present specification, a numerical range expressed using “to” means a range that includes the proceeding and succeeding numerical values of “to” as a lower limit value and an upper limit value, respectively.

In the present specification, Re(λ) and Rth(λ) represent an in-plane retardation at a wavelength λ and a thickness direction retardation at a wavelength λ, respectively. Unless otherwise specified, the wavelength λ is 550 nm.

In the present invention, Re(λ) and Rth(λ) are values measured at the wavelength λ in AxoScan OPMF-1 (manufactured by Opto Science, Inc.). By inputting an average refractive index ((nx+ny+nz)/3) and a film thickness (d (μm)) in AxoScan, a slow axis direction (°), Re(λ)=R0(λ), and Rth(λ)=((nx+ny)/2−nz)×d are calculated.

In addition, R0(λ) is expressed in a numerical value calculated with AxoScan OPMF-1, and means Re(λ).

In the present specification, the refractive indices nx, ny, and nz are measured using an Abbe refractometer (NAR-4T, manufactured by Atago Co., Ltd.) and using a sodium lamp (λ=589 nm) as a light source. In addition, in a case of measuring wavelength dependence, it can be measured with a multi-wavelength Abbe refractometer DR-M2 (manufactured by Atago Co., Ltd.) in combination with a dichroic filter.

In addition, values in Polymer Handbook (John Wiley & Sons, Inc.) and catalogs of various optical films can be used. The values of the average refractive index of main optical films are exemplified below: cellulose acylate (1.48), cycloolefin polymer (1.52), polycarbonate (1.59), polymethylmethacrylate (1.49), and polystyrene (1.59).

In the present specification, a relationship between angles (for example, “orthogonal”, “parallel”, and the like) is intended to include a range of errors acceptable in the art to which the present invention belongs. For example, it means that an angle is in an error range of ±5° with respect to the exact angle, and the error with respect to the exact angle is preferably in a range of ±3°.

A bonding direction of a divalent group (for example, —COO—) described in the present specification is not particularly limited. For example, in a case where L in X-L-Y is —COO— and in a case where the position bonded to the X side is defined as *1 and the position bonded to the Y side is defined as *2, L may be *1-O—CO-*2 or *1-CO—O-*2.

In the present specification, “(meth)acrylic” is a concept including both “acrylic” and “methacrylic”. “(meth)acryloyl group” is a concept including both “acryloyl group” and “methacryloyl group”.

In the present specification, a visible light region means a wavelength range of 400 to 700 nm. In addition, an infrared region means a wavelength range of 700 to 2,500 nm (preferably, a wavelength range of more than 700 nm and 2,500 nm or less).

### <Optically Anisotropic Film>

The optically anisotropic film of the present invention contains a liquid crystal compound or a polymer, and an aggregate of organic compounds (hereinafter, also referred to as “specific aggregate”), in which the optically anisotropic film has no absorption in a visible light region, an average value of ratios of lengths of major axes of the specific aggregate to lengths of minor axes of the specific aggregate (hereinafter, also referred to as “average aspect ratio”) is 2.0 or more, and an average length of the minor axes of the specific aggregate is 10 nm or more.

A feature point of the optically anisotropic film according to the embodiment of the present invention is that the optically anisotropic film contains the specific aggregate.

It is presumed that the specific aggregate has excellent aligning properties, light resistance, and moisture-heat resistance because the specific aggregate has a predetermined average aspect ratio and a predetermined length of the major axis. These effects are likely to occur particularly in an infrared region.

The aligning properties represent absorption anisotropy of the optically anisotropic film, and as the absorption anisotropy is higher, the aligning properties is excellent. Specifically, as will be described later, this corresponds to a high alignment degree.

Hereinafter, the fact that at least one of the effects that the aligning properties are more excellent, the light resistance is more excellent, or the moisture-heat resistance is more excellent is obtained is also referred to that the effect of the present invention is more excellent.

### (Liquid Crystal Compound)

The optically anisotropic film contains a liquid crystal compound or a polymer.

The liquid crystal compound may be either a low-molecular-weight liquid crystal compound or a high-molecular-weight liquid crystal compound (liquid crystal polymer).

The low-molecular-weight liquid crystal compound is a compound having no repeating unit in a chemical structure, and the liquid crystal polymer is a compound having a repeating unit in a chemical structure. The above-described repeating unit will be described later.

The liquid crystal compound may be either thermotropic liquid crystalline or lyotropic liquid crystalline, and is preferably lyotropic liquid crystalline.

The lyotropic liquid crystallinity refers to a property of causing a phase transition between an isotropic phase and a liquid crystal phase by changing a concentration in a solution state of being dissolved in a solvent. From the viewpoint that it is easy to control the expression of liquid crystallinity, the liquid crystal compound exhibiting lyotropic liquid crystallinity is preferably water-soluble. The water-soluble liquid crystal compound refers to a liquid crystal compound which is dissolved in water by 1% by mass or more, and is preferably a liquid crystal compound which is dissolved in water by 5% by mass or more.

The thermotropic liquid crystallinity refers to a property of causing a phase transition from an isotropic phase to a liquid crystal phase by changing a temperature.

The liquid crystal compound may exhibit any of nematic properties, smectic properties, or columnar properties.

It is preferable that the liquid crystal compound does not exhibit absorption in a visible light region (wavelength range of 400 to 700 nm).

Specifically, an average transmittance in the visible light region is 90% or more. The above-described average transmittance is preferably 95% or more. The upper limit thereof may be less than 100%.

The average transmittance can be measured, for example, using an ultraviolet-visible-near infrared spectrophotometer V-660 including UV-3100PC (manufactured by Shimadzu Corporation) or an automatic absolute reflectivity measuring unit ARMN-735 manufactured by Jasco Corporation.

Examples of the liquid crystal compound include a rod-like compound and a plate-like compound.

As the liquid crystal compound, only the rod-like compound may be used, only the plate-like compound may be used, or the rod-like compound and the plate-like compound may be used in combination.

Hereinafter, the rod-like compound and the plate-like compound will be described in detail.

### —Rod-Like Compound—

The rod-like compound refers to a compound having a structure in which ring structures (for example, an aromatic ring, a non-aromatic ring, and the like) are one-dimensionally connected through a single bond or a divalent linking group, and refers to a group of compounds which have a property of aligning major axes thereof to each other in a solvent.

The rod-like compound is preferably a lyotropic liquid crystal compound.

The rod-like compound preferably has a maximal absorption wavelength in a wavelength range of 300 nm or less. That is, the rod-like compound preferably has a maximal absorption peak in a wavelength range of 300 nm or less.

The maximal absorption wavelength of the above-described rod-like compound means a wavelength at which absorbance is the maximal value in an absorption spectrum of the rod-like compound (measurement range: wavelength range of 230 to 400 nm). In a case where there are a plurality of maximal values in the absorbance of the absorption spectrum of the rod-like compound, a wavelength on the longest wavelength side in the measurement range is selected.

From the viewpoint that the aligning properties of the specific aggregate in the optically anisotropic film are more excellent, the rod-like compound preferably has a maximal absorption wavelength in a wavelength range of 230 to 300 nm, and more preferably has a maximal absorption wavelength in a wavelength range of 250 to 290 nm. In the above-described range, the maximal absorption wavelength of the rod-like compound is also preferably in a range of 230 nm or more, and more preferably in a range of 250 nm or more.

A measuring method of the above-described maximal absorption wavelength is as follows.

The rod-like compound (5 to 50 mg) is dissolved in pure water (1,000 mL), and using a spectrophotometer (MPC-3100 (manufactured by Shimadzu Corporation)), an absorption spectrum of the obtained solution is measured.

From the viewpoint that the aligning properties of the specific aggregate in the optically anisotropic film are more excellent, the rod-like compound preferably has a hydrophilic group. The rod-like compound may have one or two or more hydrophilic groups.

Examples of the hydrophilic group include an acid group or a salt thereof, an onium base, a hydroxy group or a salt thereof, a sulfonamide group (H₂N—SO₂—) or a salt thereof, and a group including a polyoxyalkylene group; and an acid group or a salt thereof is preferable.

The onium base is a group derived from an onium salt, and examples thereof include an ammonium base (*—N⁺(R^{Z})₃A⁻), a phosphonium base (*—P⁺(R^{Z})₃A⁻), and a sulfonium base (*—S⁺(R^{Z})₂A⁻). R^{Z}'s each independently represent a hydrogen atom, an alkyl group, an aryl group, or a heteroaryl group. A⁻ represents an anion (for example, a halogen ion and the like). * represents a bonding position.

The salt of the hydroxy group is represented by *—O⁻M⁺, in which M⁺ represents a cation and * represents a bonding position. Examples of the cation represented by M⁺ include a cation in a salt of an acid group, which will be described later.

Examples of the group including a polyoxyalkylene group include a group represented by R^{Z}—(O-L^{Z})ₙ—*. R^{Z} is as described above. L^{Z} represents an alkylene group. * represents a bonding position. n represents an integer of 2 or more.

Examples of the acid group or a salt thereof include a sulfo group (—SO₃H) or a salt thereof (—SO₃⁻M⁺; M⁺ represents a cation), and a carboxyl group (—COOH) or a salt thereof (—COO⁻M⁺; M⁺ represents a cation); and from the viewpoint that the aligning properties of the specific aggregate in the optically anisotropic film are more excellent, a sulfo group or a salt thereof is preferable.

The above-described salt refers to a salt in which a hydrogen ion of the acid is replaced with another cation such as metal. That is, the salt of the acid group refers to a salt in which the hydrogen ion of the acid group such as a —SO₃H group is replaced with another cation.

Examples of the cation in the salt of the acid group (for example, a cation in the salt of a sulfo group and a cation in the salt of a carboxyl group) include Na⁺, K⁺, Li⁺, Rb⁺, Cs⁺, Ba²⁺, Ca²⁺, Mg²⁺, Sr²⁺, Pb²⁺, Zn²⁺, La³⁺, Ce³⁺, Y³⁺, Yb³⁺, Gd³⁺, and Zr⁴⁺. Among these, from the viewpoint that the aligning properties of the specific aggregate in the optically anisotropic film are more excellent, an alkali metal ion is preferable, Na⁺, K⁺, or Li⁺ is more preferable, and K⁺ is still more preferable.

As the rod-like compound, from the viewpoint that the aligning properties of the specific aggregate in the optically anisotropic film are more excellent, a liquid crystal polymer having a repeating unit represented by Formula (X) is preferable. The above-described liquid crystal polymer preferably exhibits lyotropic liquid crystallinity. That is, the above-described liquid crystal polymer is preferably a lyotropic liquid crystal compound.

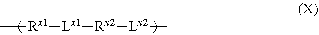

R^{x1} represents a divalent aromatic ring group having a substituent including a hydrophilic group, a divalent non-aromatic ring group having a substituent including a hydrophilic group, or a group represented by Formula (X1). In Formula (X1), * represents a bonding position.

*—R^{x3}-L^{x3}-R^{x4}-* Formula (X1)

R^{x3} and R^{x4} each independently represent a divalent aromatic ring group which may have a substituent including a hydrophilic group or a divalent non-aromatic ring group which may have a substituent including a hydrophilic group, in which at least one of R^{x3} or R^{x4} represents a divalent aromatic ring group having a substituent including a hydrophilic group or a divalent non-aromatic ring group having a substituent including a hydrophilic group.

L^{x3} represents a single bond, —O—, —S—, an alkylene group, an alkenylene group, or an alkynylene group.

The divalent aromatic ring group and the divalent non-aromatic ring group represented by R^{x1} have a substituent including a hydrophilic group.

The hydrophilic group included in the substituent including a hydrophilic group is as described above, and an acid group or a salt thereof is preferable.

The substituent including a hydrophilic group is preferably a group represented by Formula (H). In Formula (H), * represents a bonding position.

R^{H}-L^{H}-* Formula (H)

R^{H} represents a hydrophilic group. The definition of the hydrophilic group is as described above.

L^{H} represents a single bond or a divalent linking group. The divalent linking group is not particularly limited, and examples thereof include a divalent hydrocarbon group (for example, a divalent aliphatic hydrocarbon group such as an alkylene group having 1 to 10 carbon atoms, an alkenylene group having 1 to 10 carbon atoms, or an alkynylene group having 1 to 10 carbon atoms, and a divalent aromatic hydrocarbon ring group such as an arylene group); a divalent heterocyclic group, —O—, —S—, —SO₂—, —NH—, —CO—, and a group obtained by combining these groups (for example, —CO—O—, —O-divalent hydrocarbon group-, —(O-divalent hydrocarbon group)ₘ-O— (m represents an integer of 1 or more), -divalent hydrocarbon group-O—CO—, and the like).

The number of substituents including a hydrophilic group in the divalent aromatic ring group is not particularly limited, but from the viewpoint that the aligning properties of the specific aggregate in the optically anisotropic film are more excellent, it is preferably 1 to 3 and more preferably 1.

The number of substituents including a hydrophilic group in the divalent non-aromatic ring group is not particularly limited, but from the viewpoint that the aligning properties of the specific aggregate in the optically anisotropic film are more excellent, it is preferably 1 to 3 and more preferably 1.

An aromatic ring constituting the divalent aromatic ring group having the substituent including a hydrophilic group, represented by R^{x1}, may have a monocyclic structure or a polycyclic structure.

Examples of the aromatic ring constituting the above-described divalent aromatic ring group include an aromatic hydrocarbon ring and an aromatic heterocyclic ring. That is, examples of R^{x1} include a divalent aromatic hydrocarbon ring group having the substituent including a hydrophilic group and a divalent aromatic heterocyclic group having the substituent including a hydrophilic group.

Examples of the aromatic hydrocarbon ring include a benzene ring and a naphthalene ring.

Examples of a structure of only the divalent aromatic hydrocarbon ring group portion of the divalent aromatic hydrocarbon ring group having the substituent including a hydrophilic group include the following group. * represents a bonding position.

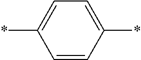 [SMILES: *c1ccc(*)cc1]

Examples of the aromatic heterocyclic ring include a pyridine ring, a thiophene ring, a pyrimidine ring, a thiazole ring, a furan ring, a pyrrole ring, an imidazole ring, and an indole ring.

Examples of a structure of only the divalent aromatic heterocyclic group portion of the divalent aromatic heterocyclic group which may have a substituent include the following groups. * represents a bonding position.

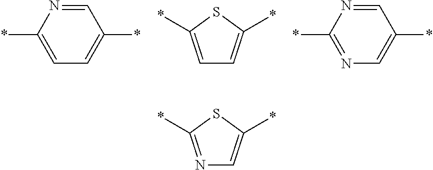

A non-aromatic ring constituting the divalent non-aromatic ring group having the substituent including a hydrophilic group, represented by R^{x1}, may have a monocyclic structure or a polycyclic structure.

Examples of the non-aromatic ring constituting the above-described divalent non-aromatic ring group include an aliphatic ring and a non-aromatic heterocyclic ring, and from the viewpoint that the aligning properties of the specific aggregate in the optically anisotropic film are more excellent, an aliphatic ring is preferable, cycloalkane is more preferable, and cyclohexane is still more preferable. That is, examples of R^{x1} include a divalent aliphatic ring group having a substituent including a hydrophilic group and a divalent non-aromatic heterocyclic group having a substituent including a hydrophilic group, and a divalent cycloalkylene group having a substituent including a hydrophilic group is preferable.

The aliphatic ring may be a saturated aliphatic ring or an unsaturated aliphatic ring.

Examples of a structure of only the divalent aliphatic ring group portion of the divalent aliphatic ring group having the substituent including a hydrophilic group include the following groups. * represents a bonding position.

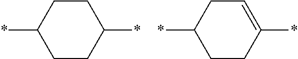

A heteroatom included in the non-aromatic heterocyclic ring is not particularly limited; and examples thereof include an oxygen atom, a nitrogen atom, and a sulfur atom.

The number of heteroatoms included in the non-aromatic heterocyclic ring is not particularly limited, and examples thereof include 1 to 3.

Examples of a structure of only the divalent non-aromatic heterocyclic group portion of the divalent non-aromatic heterocyclic group having the substituent including a hydrophilic group include the following group. * represents a bonding position.

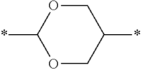 [SMILES: *C1COC(*)OC1]

The divalent aromatic ring group having a substituent including a hydrophilic group and the divalent non-aromatic ring group having a substituent including a hydrophilic group, represented by R^{x1}, may have a substituent other than the substituent including a hydrophilic group.

The substituent is not particularly limited, and examples thereof include an alkyl group, an alkenyl group, an alkynyl group, an aryl group, an amino group, an alkoxy group, an aryloxy group, an aromatic heterocyclic oxy group, an acyl group, an alkoxycarbonyl group, an aryloxycarbonyl group, an acyloxy group, an acylamino group, an alkoxycarbonylamino group, an aryloxycarbonylamino group, an alkylthio group, an arylthio group, an aromatic heterocyclic thio group, a ureido group, a halogen atom, a cyano group, a hydrazino group, a heterocyclic group (for example, a heteroaryl group), a silyl group, and a group obtained by combining these groups. The above-described substituent may be further substituted with a substituent.

R^{x3} and R^{x4} each independently represent a divalent aromatic ring group which may have a substituent including a hydrophilic group or a divalent non-aromatic ring group which may have a substituent including a hydrophilic group, in which at least one of R^{x3} or R^{x4} represents a divalent aromatic ring group having a substituent including a hydrophilic group or a divalent non-aromatic ring group having a substituent including a hydrophilic group.

The definition of the substituent including a hydrophilic group, which may be included in the divalent aromatic ring group represented by R^{x3} and R^{x4}, is as described above.

In addition, the definition of the aromatic ring constituting the divalent aromatic ring group, which may have the substituent including a hydrophilic group and is represented by R^{x3} and R^{x4}, is the same as the definition of the aromatic ring constituting the above-described divalent aromatic ring group having the substituent including a hydrophilic group, represented by R^{x1}.

The definition of the substituent including a hydrophilic group, which may be included in the divalent non-aromatic ring group represented by R^{x3} and R^{x4}, is as described above.

In addition, the definition of the non-aromatic ring constituting the divalent non-aromatic ring group, which may have the substituent including a hydrophilic group and is represented by R^{x3} and R^{x4}, is the same as the definition of the non-aromatic ring constituting the above-described divalent non-aromatic ring group having the substituent including a hydrophilic group, represented by R^{x1}.

At least one of R^{x3} or R^{x4} represent a divalent aromatic ring group having the substituent including a hydrophilic group or a divalent non-aromatic ring group having the substituent including a hydrophilic group, in which both R^{x3} and R^{x4} may represent the divalent aromatic ring group having the substituent including a hydrophilic group or the divalent non-aromatic ring group having the substituent including a hydrophilic group.

The definition of the divalent aromatic ring group having the substituent including a hydrophilic group, represented by R^{x3} and R^{x4}, has the same meaning as the above-described divalent aromatic ring group having the substituent including a hydrophilic group, represented by R^{x1}.

In addition, the definition of the divalent non-aromatic ring group having the substituent including a hydrophilic group, represented by R^{x3} and R^{x4}, has the same meaning as the above-described divalent non-aromatic ring group having the substituent including a hydrophilic group, represented by R^{x1}.

L^{x3} represents a single bond, —O—, —S—, an alkylene group, an alkenylene group, or an alkynylene group.

The number of carbon atoms in the alkylene group is not particularly limited, but from the viewpoint that the aligning properties of the specific aggregate in the optically anisotropic film are more excellent, it is preferably 1 to 3 and more preferably 1.

The number of carbon atoms in the alkenylene group and in the alkynylene group is not particularly limited, but from the viewpoint that the aligning properties of the specific aggregate in the optically anisotropic film is more excellent, it is preferably 2 to 5 and more preferably 2 to 4.

R^{x2} represents a divalent non-aromatic ring group, a divalent aromatic ring group, or a group represented by Formula (X2). In Formula (X2), * represents a bonding position.

*—Z^{x1}—Z^{x2}—* Formula (X2)

Z^{x1} and Z^{x2} each independently represent a divalent non-aromatic ring group or a divalent aromatic ring group. * represents a bonding position.

A non-aromatic ring constituting the divalent non-aromatic ring group represented by R^{x2} may have a monocyclic structure or a polycyclic structure.

Examples of the non-aromatic ring constituting the above-described divalent non-aromatic ring group include an aliphatic ring and a non-aromatic heterocyclic ring, and from the viewpoint that the aligning properties of the specific aggregate in the optically anisotropic film are more excellent, an aliphatic ring is preferable, cycloalkane is more preferable, and cyclohexane is still more preferable. That is, examples of R^{x2} include a divalent aliphatic ring group and a divalent non-aromatic heterocyclic group, and a divalent cycloalkylene group is preferable.

The aliphatic ring may be a saturated aliphatic ring or an unsaturated aliphatic ring.

Examples of the divalent aliphatic ring group include the following groups. * represents a bonding position.

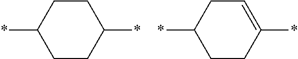

A heteroatom included in the non-aromatic heterocyclic ring is not particularly limited; and examples thereof include an oxygen atom, a nitrogen atom, and a sulfur atom.

The number of heteroatoms included in the non-aromatic heterocyclic ring is not particularly limited, and examples thereof include 1 to 3.

Examples of the divalent non-aromatic heterocyclic group include the following group. * represents a bonding position.

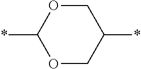 [SMILES: *C1COC(*)OC1]

The divalent non-aromatic ring group may have a substituent. The type of the substituent is not particularly limited; and examples thereof include the groups exemplified by the substituent other than the substituent including a hydrophilic group, which may be included in the divalent aromatic ring group having the substituent including a hydrophilic group or the divalent non-aromatic ring group having the substituent including a hydrophilic group, represented by R^{x1}.

An aromatic ring constituting the divalent aromatic ring group represented by R^{x2} may have a monocyclic structure or a polycyclic structure.

Examples of the aromatic ring include an aromatic hydrocarbon ring and an aromatic heterocyclic ring.

Examples of the aromatic hydrocarbon ring include a benzene ring and a naphthalene ring.

Examples of the aromatic heterocyclic ring include a pyridine ring, a thiophene ring, a pyrimidine ring, a thiazole ring, a furan ring, a pyrrole ring, an imidazole ring, and an indole ring.

The divalent aromatic ring group may have a substituent. The type of the substituent is not particularly limited; and examples thereof include the groups exemplified by the substituent other than the substituent including a hydrophilic group, which may be included in the divalent aromatic ring group having the substituent including a hydrophilic group or the divalent non-aromatic ring group having the substituent including a hydrophilic group, represented by R^{x1}.

Z^{x1} and Z^{x2} each independently represent a divalent non-aromatic ring group or a divalent aromatic ring group.

The definition of the divalent non-aromatic ring group represented by Z^{x1} and Z^{x2} and the definition of the divalent aromatic ring group are the same as the definition of the divalent non-aromatic ring group represented by R^{x2} and the definition of the divalent aromatic ring group described above.

L^{x1} and L^{x2} each independently represent —CONH—, —COO—, —O—, or —S—. Among these, from the viewpoint that the aligning properties of the specific aggregate are more excellent, —CONH— is preferable.

The repeating unit represented by Formula (X) is preferably a repeating unit represented by Formula (X4).

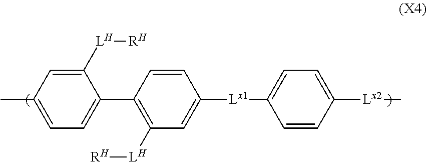

The definition of each group in Formula (X4) is as described above.

A content of the repeating unit represented by Formula (X) included in the liquid crystal polymer having the repeating unit represented by Formula (X) is not particularly limited, but is preferably 60% by mole or more and more preferably 80% by mole or more with respect to all repeating units in the liquid crystal polymer. The upper limit thereof is, for example, 100% by mole or less.

A molecular weight of the liquid crystal polymer having the repeating unit represented by Formula (X) is not particularly limited, and the number of repeating units represented by Formula (X) in the liquid crystal polymer is preferably 2 or more, more preferably 10 to 100,000, and still more preferably 100 to 10,000.

In addition, a number-average molecular weight of the liquid crystal polymer having the repeating unit represented by Formula (X) is not particularly limited, but is preferably 5,000 to 50,000 and more preferably 10,000 to 30,000.

In addition, a molecular weight distribution of the liquid crystal polymer having the repeating unit represented by Formula (X) is not particularly limited, but is preferably 1.0 to 12.0 and more preferably 1.0 to 7.0.

Here, the number-average molecular weight and the molecular weight distribution in the present invention are values measured by a gel permeation chromatography (GPC) method. Specific method thereof is as follows.
Solvent (eluent): 20 mM phosphate (pH: 7.0)/acetonitrile=4/1
Device name: TOSOH HLC-8220GPC
Column: using three columns of G6000PWxL, 4500PWxL, and G2500pWwL manufactured by Tosoh Corporation connected with each other
Column temperature: 40° C.
Sample concentration: 2 mg/mL
Flow rate: 1 mL/min
Calibration curve: calibration curve using 8 samples up to polystyrene sulfonic acid (PSS) Mp=891, 4.2 k, 10.2 k, 29.5 k, 78.4 k, 152 k, 258 k, and 462 k (k=×10³)

### —Plate-Like Compound—

The plate-like compound refers to a compound having a structure in which aromatic rings (for example, an aromatic hydrocarbon ring, an aromatic heterocyclic ring, and the like) are spread two-dimensionally through a single bond or an appropriate linking group, and refers to a group of compounds which have a property of forming column-like associate by associating planes in the compound in a solvent.

The plate-like compound is preferably a lyotropic liquid crystal compound.

The plate-like compound preferably has a maximal absorption wavelength in a wavelength range of more than 300 nm. That is, the plate-like compound preferably has a maximal absorption peak in a wavelength range of more than 300 nm.

The maximal absorption wavelength of the above-described plate-like compound means a wavelength at which absorbance is the maximal value in an absorption spectrum of the plate-like compound (measurement range: wavelength range of 230 to 400 nm). In a case where there are a plurality of maximal values in the absorbance of the absorption spectrum of the plate-like compound, a wavelength on the longest wavelength side in the measurement range is selected.

Among these, the plate-like compound preferably has a maximal absorption wavelength in a wavelength range of 320 to 400 nm, and more preferably has a maximal absorption wavelength in a wavelength range of 330 to 360 nm. In the above-described range, the maximal absorption wavelength of the plate-like compound is also preferably in a range of 320 nm or more, and more preferably in a range of 330 nm or more.

A measuring method of the above-described maximal absorption wavelength is as follows.

The plate-like compound (0.01 to 0.05 mmol) is dissolved in pure water (1,000 mL), and using a spectrophotometer (MPC-3100 (manufactured by Shimadzu Corporation)), an absorption spectrum of the obtained solution is measured.

From the viewpoint that the aligning properties of the specific aggregate in the optically anisotropic film are more excellent, the plate-like compound preferably has a hydrophilic group.

The definition of the hydrophilic group is the same as the definition of the hydrophilic group which may be included in the rod-like compound.

The plate-like compound may have one or two or more hydrophilic groups. In a case where the plate-like compound has a plurality of hydrophilic groups, the number thereof is preferably 2 to 4 and more preferably 2.

From the viewpoint that the aligning properties of the specific aggregate in the optically anisotropic film are more excellent, the plate-like compound is preferably a compound represented by Formula (Y). The compound represented by Formula (Y) is preferably a lyotropic liquid crystal compound.

R^{y2}-L^{y3}-L^{y1}-R^{y1}-L^{y2}-L^{y4}-R^{y3} Formula (Y)

R^{y1} represents a divalent monocyclic group which may have a substituent or a divalent fused polycyclic group which may have a substituent.

Examples of a ring included in the divalent monocyclic group include a monocyclic hydrocarbon ring and a monocyclic heterocyclic ring. The monocyclic hydrocarbon ring may be a monocyclic aromatic hydrocarbon ring or a monocyclic non-aromatic hydrocarbon ring. The monocyclic heterocyclic ring may be a monocyclic aromatic heterocyclic ring or a monocyclic non-aromatic heterocyclic ring.

From the viewpoint that the aligning properties of the specific aggregate in the optically anisotropic film are more excellent, the divalent monocyclic group is preferably a divalent monocyclic aromatic hydrocarbon ring group or a divalent monocyclic aromatic heterocyclic group.

The number of ring structures included in the divalent fused polycyclic group is not particularly limited, but from the viewpoint that the aligning properties of the specific aggregate in the optically anisotropic film are more excellent, it is preferably 3 to 10, more preferably 3 to 6, and still more preferably 3 or 4.

Examples of the ring included in the divalent fused polycyclic group include a hydrocarbon ring and a heterocyclic ring. The hydrocarbon ring may be an aromatic hydrocarbon ring or a non-aromatic hydrocarbon ring. The heterocyclic ring may be an aromatic heterocyclic ring or a non-aromatic heterocyclic ring.

From the viewpoint that the aligning properties of the specific aggregate in the optically anisotropic film are more excellent, the divalent fused polycyclic group is preferably composed of an aromatic hydrocarbon ring and a heterocyclic ring. The divalent fused polycyclic group is preferably a conjugated linking group. That is, the divalent fused polycyclic group is preferably a conjugated divalent fused polycyclic group.

Examples of the ring constituting the divalent fused polycyclic group include dibenzothiophene-S,S-dioxide (a ring represented by Formula (Y2)), dinaphtho[2,3-b:2′,3′-d]furan (a ring represented by Formula (Y3)), 12H-benzo“b”phenoxazine (a ring represented by Formula (Y4)), dibenzo[b,i]oxantrene (a ring represented by Formula (Y5)), benzo[b]naphtho[2′,3′:5,6]dioxino[2,3-i]oxantrene (a ring represented by Formula (Y6)), acenaphtho[1,2-b]benzo[g]quinoxaline (a ring represented by Formula (Y7)), 9H-acenaphtho[1,2-b]imidazo[4,5-g]quinoxaline (a ring represented by Formula (Y8)), dibenzo[b,def]chrysene-7,14-dione (a ring represented by Formula (Y9)), and acetonaphthoquinoxaline (a ring represented by Formula (Y10)).

That is, examples of the divalent fused polycyclic group include divalent groups formed by removing two hydrogen atoms from rings represented by any of Formulae (Y2) to (Y10); and a divalent group formed by removing two hydrogen atoms from a ring represented by Formula (Y2) is preferable.

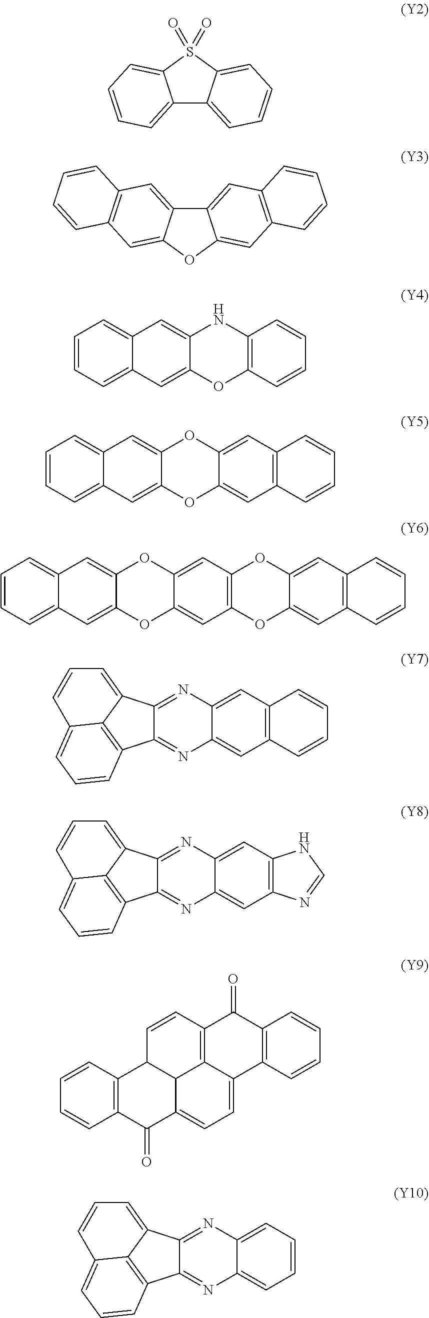

The divalent monocyclic group and the divalent fused polycyclic group may have a substituent. The type of the substituent is not particularly limited; and examples thereof include the groups exemplified by the substituent other than the substituent including a hydrophilic group, which are included in the divalent aromatic ring group having the substituent including a hydrophilic group or the divalent non-aromatic ring group having the substituent including a hydrophilic group, represented by R^{x1}.

R^{y2} and R^{y3} each independently represent a hydrogen atom or a hydrophilic group, and at least one of R^{y2} or R^{y3} represents a hydrophilic group. It is preferable that both R^{y2} and R^{y3} represent a hydrophilic group.

The definition of the hydrophilic group represented by R^{y2} and R^{y3} is as described above.

L^{y1} and L^{y2} each independently represent a single bond, a divalent aromatic ring group, or a group represented by Formula (Y1). However, in a case where R^{y1} is a divalent monocyclic group, both L^{y1} and L^{y2} represent a divalent aromatic ring group or a group represented by Formula (Y1).

*—R^{y4}—(R^{y5})ₙ—* Formula (Y1)

In Formula (Y1), * represents a bonding position. R^{y4} and R^{y5} each independently represent a divalent aromatic ring group. n represents 1 or 2.

An aromatic ring constituting the divalent aromatic ring group represented by L^{y1} and L^{y2} may have a monocyclic structure or a polycyclic structure.

Examples of the aromatic ring constituting the above-described divalent aromatic ring group include an aromatic hydrocarbon ring and an aromatic heterocyclic ring. That is, examples of the divalent aromatic ring group represented by L^{y1} and L^{y2} include a divalent aromatic hydrocarbon ring group and a divalent aromatic heterocyclic group.

Examples of the aromatic hydrocarbon ring include a benzene ring and a naphthalene ring.

Examples of the divalent aromatic hydrocarbon ring group include the following group. * represents a bonding position.

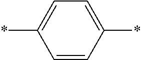 [SMILES: *c1ccc(*)cc1]

Examples of the aromatic heterocyclic ring include a pyridine ring, a thiophene ring, a pyrimidine ring, a thiazole ring, a furan ring, a pyrrole ring, an imidazole ring, and an indole ring.

Examples of the divalent aromatic heterocyclic group include the following groups. * represents a bonding position.

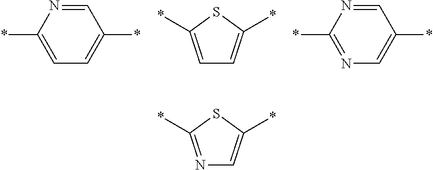

The definition of the divalent aromatic ring group represented by R^{y4} and R^{y5} is also the same as the divalent aromatic ring group represented by L^{y1} and L^{y2}.

L^{y3} and L^{y4} each independently represent a single bond, —O—, —S—, an alkylene group, an alkenylene group, an alkynylene group, or a group obtained by combining these groups.

Examples of the above-described group obtained by combining these groups include —O-alkylene group- and —S-alkylene group-.

The number of carbon atoms in the alkylene group is not particularly limited, but from the viewpoint that the aligning properties of the specific aggregate in the optically anisotropic film are more excellent, it is preferably 1 to 3 and more preferably 1.

The number of carbon atoms in the alkenylene group and in the alkynylene group is not particularly limited, but from the viewpoint that the aligning properties of the specific aggregate in the optically anisotropic film is more excellent, it is preferably 2 to 5 and more preferably 2 to 4.

The liquid crystal compound is also preferably a liquid crystal polymer having a repeating unit represented by Formula (1).

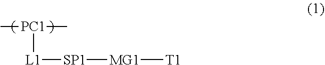

In Formula (1), PC1 represents a main chain of the repeating unit, L1 represents a single bond or a divalent linking group, SP1 represents a spacer group, MG1 represents a mesogen group, and T1 represents a terminal group.

Examples of the main chain of the repeating unit, represented by PC1, include groups represented by any of Formulae (P1-A) to (P1-D); and from the viewpoint of diversity and handleability of a monomer serving as a raw material, a group represented by Formula (P1-A) is preferable.

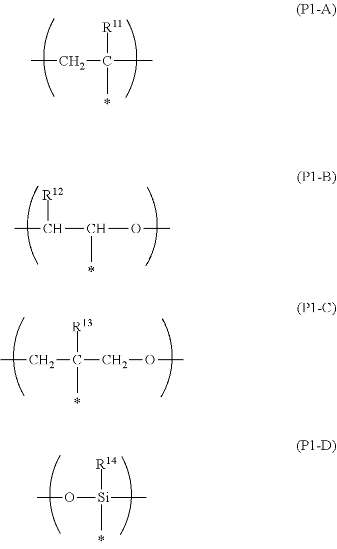

In Formulae (P1-A) to (P1-D), * represents a bonding position to L1 in Formula (1). In Formulae (P1-A) to (P1-D), R¹¹ to R¹⁴ each independently represent a hydrogen atom, a halogen atom, a cyano group, an alkyl group having 1 to 10 carbon atoms, or an alkoxy group having 1 to 10 carbon atoms. The above-described alkyl group may be a linear or branched alkyl group, or an alkyl group having a cyclic structure (cycloalkyl group). In addition, the number of carbon atoms in the above-described alkyl group is preferably 1 to 5.

It is preferable that the group represented by Formula (P1-A) is one unit of a partial structure of poly(meth)acrylic acid ester, which is obtained by polymerization of (meth)acrylic acid ester.

It is preferable that the group represented by Formula (P1-B) is an ethylene glycol unit formed by ring-opening polymerization of an epoxy group of a compound having the epoxy group.

It is preferable that the group represented by Formula (P1-C) is a propylene glycol unit formed by ring-opening polymerization of an oxetane group of a compound having the oxetane group.

It is preferable that the group represented by Formula (P1-D) is a siloxane unit of a polysiloxane obtained by polycondensation of a compound having at least one of an alkoxysilyl group or a silanol group. Here, examples of the compound having at least one of an alkoxysilyl group or a silanol group include a compound having a group represented by SiR¹⁴(OR¹⁵)₂—. R¹⁴ has the same definition as that for R¹⁴ in Formula (P1-D), and a plurality of R¹⁵'s each independently represent a hydrogen atom or an alkyl group having 1 to 10 carbon atoms.

Examples of the divalent linking group represented by L1 include —CO—, —COO—, —O—, —S—, —CONR¹⁶—, —SO₂—, and —NR¹⁶R¹⁷—. R¹⁶ and R¹⁷ each independently represent a hydrogen atom or an alkyl group having 1 to 6 carbon atoms, which may have a substituent (for example, the group exemplified by the substituent W described above).

In a case where PC1 represents the group represented by Formula (P1-A), it is preferable that L1 is a group represented by —COO— or —CONR¹⁶—.

In a case where PC1 represents the group represented by any of Formulae (P1-B) to (P1-D), it is preferable that L1 is a single bond.

As the spacer group represented by SP1, a group having at least one structure selected from the group consisting of an oxyethylene structure, an oxypropylene structure, a polysiloxane structure, and an alkylene fluoride structure, or a linear or branched alkylene group having 2 to 20 carbon atoms is preferable. The above-described alkylene group may further include —O—, —S—, —COO—, —O—CO—O—, —CONR— (R represents an alkyl group having 1 to 10 carbon atoms), or —SO₂—.

From the viewpoint of easily expressing liquid crystallinity and availability of raw materials, it is more preferable that the spacer group represented by SP1 is a group having at least one structure selected from the group consisting of an oxyethylene structure, an oxypropylene structure, a polysiloxane structure, and an alkylene fluoride structure.

Here, the oxyethylene structure represented by SP1 is preferably a group represented by *—(CH₂—CH₂O)ₙ₁—* is preferable. In the formula, n1 represents an integer of 1 to 20 and * represents a bonding position. n is preferably an integer of 2 to 10, more preferably an integer of 2 to 6, and still more preferably an integer of 2 to 4.

In addition, the oxypropylene structure represented by SP1 is preferably a group represented by *—(CH(CH₃)—CH₂O)ₙ₂—*. In the formula, n2 represents an integer of 1 to 3 and * represents a bonding position.

In addition, the polysiloxane structure represented by SP1 is preferably a group represented by *—(Si(CH₃)₂—O)ₙ₃—*. In the formula, n3 represents an integer of 6 to 10 and * represents a bonding position.

In addition, the alkylene fluoride structure represented by SP1 is preferably a group represented by *—(CF₂—CF₂)ₙ₄—*. In the formula, n4 represents an integer of 6 to 10 and * represents a bonding position.

The mesogen group represented by MG1 is a group representing a main skeleton of a liquid crystal molecule which contributes to liquid crystal formation. A liquid crystal molecule exhibits liquid crystallinity which is in an intermediate state (mesophase) between a crystal state and an isotropic liquid state. The mesogen group is not particularly limited, and for example, particularly description on pages 7 to 16 of “Flussige Kristalle in Tabellen II” (VEB Deutsche Verlag fur Grundstoff Industrie, Leipzig, 1984) and particularly description in Chapter 3 of “Liquid Crystal Handbook” (Maruzen, 2000) edited by Liquid Crystal Handbook Editing Committee can be referred to. As the mesogen group, for example, a group having at least one cyclic structure selected from the group consisting of an aromatic hydrocarbon group, a heterocyclic group, and an alicyclic group is preferable. From the viewpoint that the effect of the present invention is more excellent, the mesogen group contains preferably an aromatic hydrocarbon group, more preferably 2 to 4 aromatic hydrocarbon groups, and still more preferably 3 aromatic hydrocarbon groups.

As the mesogen group, from the viewpoint of exhibiting the liquid crystallinity, of adjusting the liquid crystal phase transition temperature, of availability of raw materials, and of synthetic suitability, and from the viewpoint of further increasing the alignment degree of the optically anisotropic film, a group represented by Formula (M1-A) or Formula (M1-B) is preferable, and a group represented by Formula (M1-B) is more preferable.

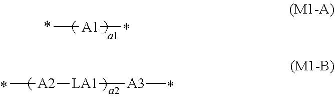

In Formula (M1-A), A1 represents a divalent group selected from the group consisting of an aromatic hydrocarbon group, a heterocyclic group, and an alicyclic group. These groups may be substituted with an alkyl group, a fluorinated alkyl group, an alkoxy group, or a substituent.

It is preferable that the divalent group represented by A1 is a 4- to 6-membered ring. In addition, the divalent group represented by A1 may be a monocyclic ring or a fused ring.

* represents a bonding position with respect to SP1 or T1.

Examples of the divalent aromatic hydrocarbon group represented by A1 include a phenylene group, a naphthylene group, a fluorene-diyl group, an anthracene-diyl group, and a tetracene-diyl group. From the viewpoint of design diversity of the mesogenic skeleton and the availability of raw materials, a phenylene group or a naphthylene group is preferable and a phenylene group is more preferable.

The divalent heterocyclic group represented by A1 may be any of aromatic or non-aromatic, but from the viewpoint of further improving the alignment degree, a divalent aromatic heterocyclic group is preferable.

Examples of atoms other than carbon, constituting the divalent aromatic heterocyclic group, include a nitrogen atom, a sulfur atom, and an oxygen atom. In a case where the aromatic heterocyclic group has a plurality of atoms other than carbon, constituting a ring, these atoms may be the same or different from each other.

Specific examples of the divalent aromatic heterocyclic group include a pyridylene group (pyridine-diyl group), a pyridazine-diyl group, an imidazole-diyl group, a thienylene group (thiophene-diyl group), a quinolylene group (quinoline-diyl group), an isoquinolylene group (isoquinoline-diyl group), an oxazole-diyl group, a thiazole-diyl group, an oxadiazole-diyl group, a benzothiazole-diyl group, a benzothiadiazole-diyl group, a phthalimido-diyl group, a thienothiazole-diyl group, a thiazolothiazole-diyl group, a thienothiophene-diyl group, and a thienooxazole-diyl group.

Specific examples of the divalent alicyclic group represented by A1 include a cyclopentylene group and a cyclohexylene group.

In Formula (M1-A), a1 represents an integer of 1 to 10. In a case where a1 represents 2 or more, a plurality of A1's may be the same or different from each other.

In Formula (M1-B), A2 and A3 each independently represent a divalent group selected from the group consisting of an aromatic hydrocarbon group, a heterocyclic group, and an alicyclic group. Specific examples and suitable aspects of A2 and A3 are the same as those for A1 in Formula (M1-A), and thus the description thereof will not be repeated.

In Formula (M1-B), a2 represents an integer of 1 to 10, and in a case where a2 is 2 or more, a plurality of A2's may be the same or different from each other, a plurality of A3's may be the same or different from each other, and a plurality of LA1's may be the same or different from each other. From the viewpoint of further increasing the alignment degree of the optically anisotropic film, a2 is preferably an integer of 2 or more and more preferably 2.

In Formula (M1-B), in a case where a2 is 1, LA1 represents a divalent linking group. In a case where a2 is 2 or more, a plurality of LA1's each independently represent a single bond or a divalent linking group, and at least one of the plurality of LA1's is a divalent linking group. In a case where a2 is 2, from the viewpoint of further increasing the alignment degree of the optically anisotropic film, it is preferable that one of two LA1's is a divalent linking group and the other is a single bond.

In Formula (M1-B), examples of the divalent linking group represented by LA1 include —O—, —(CH₂)_{g}—, —(CF₂)_{g}—, —Si(CH₃)₂—, —(Si(CH₃)₂O)_{g}—, —(OSi(CH₃)₂)_{g}— (g represents an integer of 1 to 10), —N(Z)—, —C(Z)═C(Z′)—, —C(Z)═N—, —C(Z)₂—C(Z′)₂—, —CO—, —OCO—, —O—COO—, —N(Z)CO—, —C(Z)═C(Z′)—COO—, —C(Z)═N—, —C(Z)═C(Z′)—CON(Z″)—, —C(Z)═C(Z′)—CO—S—, —C(Z)═N—N═C(Z′)— (Z, Z′, and Z″ each independently represent a hydrogen atom, a C1 to C4 alkyl group, a cycloalkyl group, an aryl group, a cyano group, or a halogen atom), —C≡C—, —N═N—, —S—, —SO—, —SOO—, —OSOO—, —OOSOO—, and —SCO—. Among these, from the viewpoint of further increasing the alignment degree of the optically anisotropic film, —COO— is preferable. LA1 may be a group obtained by combining two or more of these groups.

Examples of the terminal group represented by T1 include a hydrogen atom, a halogen atom, a cyano group, a nitro group, a hydroxy group, —SH, a carboxyl group, a boronic acid group, —SO₃H, —PO₃H₂, —NR¹¹R¹² (R¹¹ and R¹² each independently represent a hydrogen atom, a substituted or unsubstituted alkyl group having 1 to 10 carbon atoms, a cycloalkyl group, or an aryl group), an alkyl group having 1 to 10 carbon atoms, an alkoxy group having 1 to 10 carbon atoms, an alkylthio group having 1 to 10 carbon atoms, an alkoxycarbonyloxy group having 1 to 10 carbon atoms, an acyloxy group having 1 to 10 carbon atoms, an acylamino group having 1 to 10 carbon atoms, an alkoxycarbonyl group having 1 to 10 carbon atoms, an alkoxycarbonylamino group having 1 to 10 carbon atoms, a sulfonylamino group having 1 to 10 carbon atoms, a sulfamoyl group having 1 to 10 carbon atoms, a carbamoyl group having 1 to 10 carbon atoms, a sulfinyl group having 1 to 10 carbon atoms, a ureido group having 1 to 10 carbon atoms, and a crosslinkable group-containing group.

Examples of the above-described crosslinkable group-containing group include -L-CL. L represents a single bond or a divalent linking group. Examples of the divalent linking group include a substituent represented by L1. CL represents a crosslinkable group, and is preferably a crosslinkable group represented by any of Formulae (P-1) to (P-30), and more preferably an acryloyl group or a methacryloyl group. In addition, T1 may be a group obtained by combining two or more of these groups. In the following formulae, R^{P} represents a hydrogen atom or an alkyl group. * represents a bonding position.

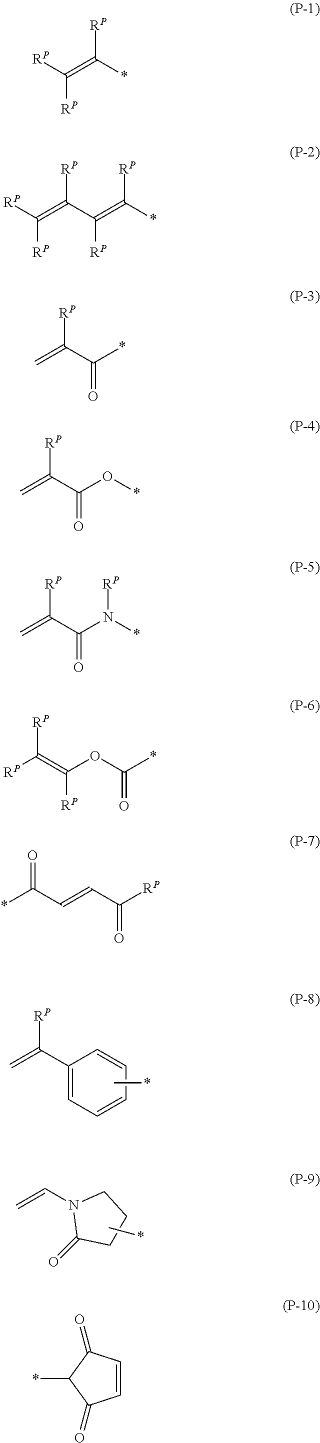

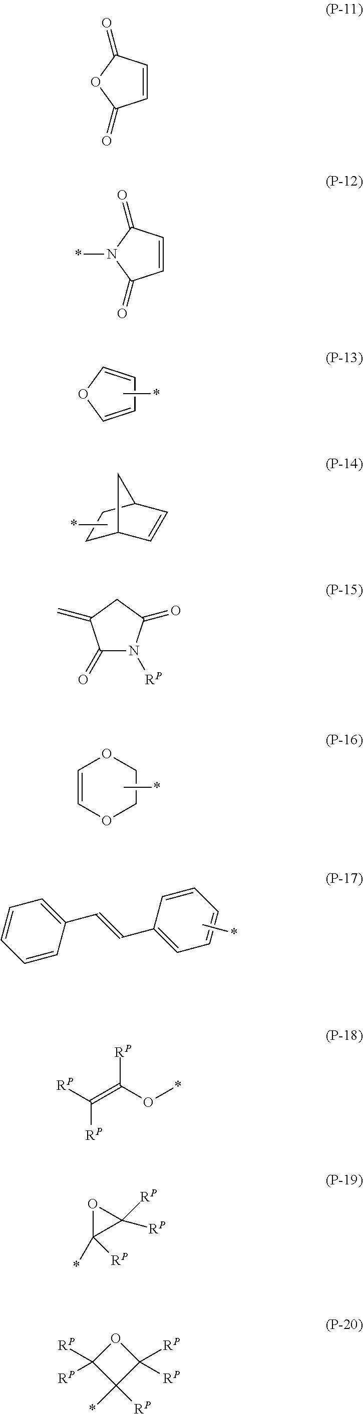

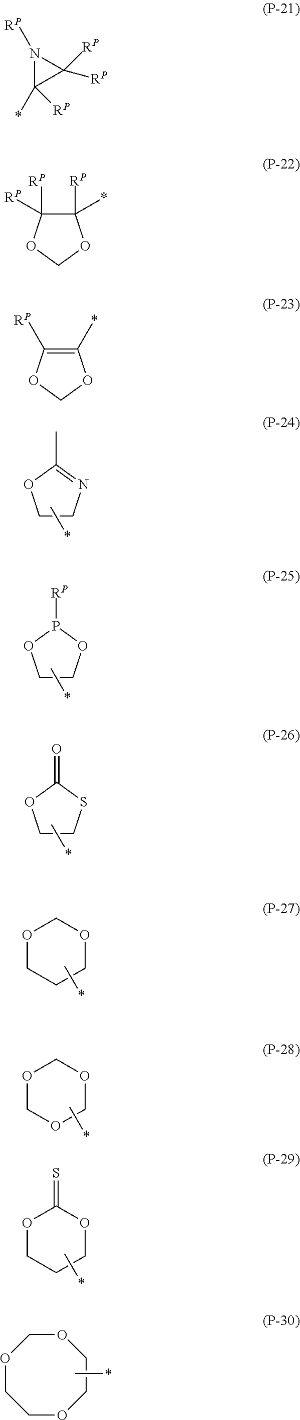

T1 is preferably an alkoxy group having 1 to 10 carbon atoms, more preferably an alkoxy group having 1 to 5 carbon atoms, and still more preferably a methoxy group. These terminal groups may be further substituted with the groups or polymerizable groups described in JP2010-244038A.

The number of atoms in the main chain of T1 is preferably 1 to 20, more preferably 1 to 15, still more preferably 1 to 10, and particularly preferably 1 to 7. In a case where the number of atoms in the main chain of T1 is 20 or less, the aligning properties of the specific aggregate in the optically anisotropic film are further improved. Here, the “main chain” of T1 means the longest molecular chain bonded to M1, and the number of hydrogen atoms is not included in the number of atoms in the main chain of T1. For example, in a case where T1 is an n-butyl group, the number of atoms in the main chain is 4, and in a case where T1 is an sec-butyl group, the number of atoms in the main chain is 3.

A content of the repeating unit (1) is preferably 40% to 100% by mass and more preferably 50% to 95% by mass with respect to all repeating units of the rod-like compound (liquid crystal rod-like polymer).

From the viewpoint of improving the aligning properties, the liquid crystal polymer preferably includes a repeating unit having an electron-donating property and/or an electron-withdrawing property at a terminal. More specifically, the liquid crystal polymer more preferably includes a repeating unit (21) having a mesogen group and an electron-withdrawing group which is present at the terminal of the mesogen group and has a σp value of more than 0, and a repeating unit (22) having a mesogen group and a group which is present at the terminal of the mesogen group and has a σp value of 0 or less. As described above, in a case where the liquid crystal polymer includes the repeating unit (21) and the repeating unit (22), the aligning properties of the optically anisotropic film to be formed of the liquid crystal polymer are further improved as compared with a case where the liquid crystal polymer includes only one of the repeating unit (21) or the repeating unit (22). The details of the reason for this are not clear, but it is presumed as follows.

That is, it is presumed that, since opposite dipole moments generated in the repeating unit (21) and the repeating unit (22) cause intermolecular interactions, an interaction between the mesogen groups in a minor axis direction is strengthened, and an orientation in which the liquid crystals are aligned is more uniform, and as a result, the degree of order of the liquid crystals is considered to be high. As a result, it is presumed that the aligning properties of the optically anisotropic film to be formed are improved because the aligning properties of the specific aggregate are also improved.

The above-described repeating units (21) and (22) may be the repeating unit represented by Formula (1) described above.

The repeating unit (21) has a mesogen group and an electron-withdrawing group which is present at the terminal of the mesogen group and has a σp value of more than 0.

The above-described electron-withdrawing group is a group which is positioned at the terminal of the mesogen group and has a σp value of more than 0. Examples of the electron-withdrawing group (group having a σp value of more than 0) include a group represented by EWG in Formula (LCP-21) described below, and specific examples thereof are also the same as those described below.

The σp value of the above-described electron-withdrawing group is more than 0, and from the viewpoint of further increasing the aligning properties of the optically anisotropic film, it is preferably 0.3 or more and more preferably 0.4 or more. From the viewpoint that the uniformity of alignment is excellent, the upper limit of the σp value of the above-described electron-withdrawing group is preferably 1.2 or less and more preferably 1.0 or less.

The σp value is a Hammett's substituent constant σp value (simply referred to as “σp value”), and is a parameter showing the intensity of the electron-withdrawing property and the electron-donating property of a substituent, which numerically expresses the effect of the substituent on the acid dissociation equilibrium constant of substituted benzoic acid. The Hammett's substituent constant σp value in the present specification indicates the substituent constant σ in a case where the substituent is positioned at the para-position of benzoic acid.

As the Hammett's substituent constant σp value of each group in the present specification, a value described in the document “Hansch et al., Chemical Reviews, 1991, Vol, 91, No. 2, pp. 165 to 195” are adopted. With regard to a group in which the Hammett's substituent constant σp value is not described in the document above, the Hammett's substituent constant σp value can be calculated using software “ACD/Chem Sketch (ACD/Labs 8.00 Release Product Version: 8.08)” based on a difference between the pKa of benzoic acid and the pKa of a benzoic acid derivative having a substituent at the para-position.

The repeating unit (21) is not particularly limited as long as it has, at a side chain thereof, the mesogen group and the electron-withdrawing group which present at the terminal of the mesogen group and has a σp value of more than 0, but from the viewpoint that the aligning properties of the specific aggregate in the optically anisotropic film are more excellent, a repeating unit represented by Formula (LCP-21) is preferable.

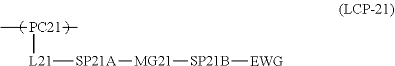

In Formula (LCP-21), PC21 represents a main chain of a repeating unit, and more specifically represents the same structure as that for PC1 in Formula (1) described above; L21 represents a single bond or a divalent linking group, and more specifically represents the same structure as that for L1 in Formula (1) described above; SP21A and SP21B each independently represent a single bond or a spacer group, and more specifically represent the same structure as that for SP1 in Formula (1) described above; MG21 represents a mesogen structure, and more specifically represents the mesogen group MG1 in Formula (1) described above; and EWG represents an electron-withdrawing group having a σp value of more than 0.

As SP21A, it is preferable to include at least one structure selected from the group consisting of an oxyethylene structure, an oxypropylene structure, a polysiloxane structure, and an alkylene fluoride structure.

As SP21B, a single bond or a linear or branched alkylene group having 2 to 20 carbon atoms is preferable. The above-described alkylene group may further include —O—, —CO—O—, or —O—CO—O—.

Among these, from the viewpoint of further increasing the aligning properties of the optically anisotropic film, the spacer group represented by SP21B is preferably a single bond. In this manner, it is presumed that, in a case where the electron-withdrawing group is directly linked to the mesogen group, the intermolecular interaction due to an appropriate dipole moment works more effectively in the rod-like compound, and the orientation in which the liquid crystals are aligned is more uniform, and as a result, the degree of order of the liquid crystals and the aligning properties are considered to be high.

EWG represents an electron-withdrawing group having a σp value of more than 0 (the σp value exceeds 0).

Examples of the electron-withdrawing group having a σp value of more than 0 include an ester group (specifically, a group represented by *—COO—R^{E}), a (meth)acryloyl group, a (meth)acryloyloxy group, a carboxy group, a cyano group, a nitro group, a sulfo group, —SOO—OR^{E}, —SOO—R^{E}, —O—SOO—R^{E}, an acyl group (specifically, a group represented by *—COR^{E}) an acyloxy group (specifically, a group represented by *—OCOR^{E}), an isocyanate group (—N═CO), *—CON(R^{F})₂, a halogen atom, and an alkyl group substituted with any of these groups (preferably having 1 to 20 carbon atoms). In each of the above-described groups, * represents a bonding position. R^{E} represents an alkyl group having 1 to 20 carbon atoms (preferably 1 to 4 carbon atoms and more preferably 1 or 2 carbon atoms). R^{F}'s each independently represents a hydrogen atom or an alkyl group having 1 to 20 carbon atoms (preferably 1 to 4 carbon atoms and more preferably 1 or 2 carbon atoms).

Among these, EWG is preferably a group represented by *—COO—R^{E}, a (meth)acryloyloxy group, a cyano group, or a nitro group.

A content of the repeating unit (21) is preferably 60% by mass or less, more preferably 50% by mass or less, and still more preferably 45% by mass or less with respect to all repeating units of the liquid crystal polymer. The lower limit value thereof is preferably 1% by mass or more and more preferably 3% by mass or more with respect to all repeating units of the liquid crystal polymer.

In a case where the liquid crystal polymer includes two or more kinds of repeating units (21), a repeating unit (21) which does not include a crosslinkable group in EWG and a repeating unit (21) which includes a polymerizable group in EWG may be used in combination. In this manner, curing properties of the optically anisotropic film are further improved. As the crosslinkable group, a vinyl group, a butadiene group, a (meth)acryloyl group, a (meth)acrylamide group, a vinyl acetate group, a fumaric acid ester group, a styryl group, a vinylpyrrolidone group, a maleic acid anhydride, a maleimide group, a vinyl ether group, an epoxy group, or an oxetanyl group is preferable.

In this case, from the viewpoint of balance between the curing properties and the aligning properties of the optically anisotropic film, the content of the repeating unit (21) including a polymerizable group in EWG is preferably 1% to 30% by mass with respect to all repeating units of the liquid crystal polymer.

Examples of the repeating unit (21) are shown below.

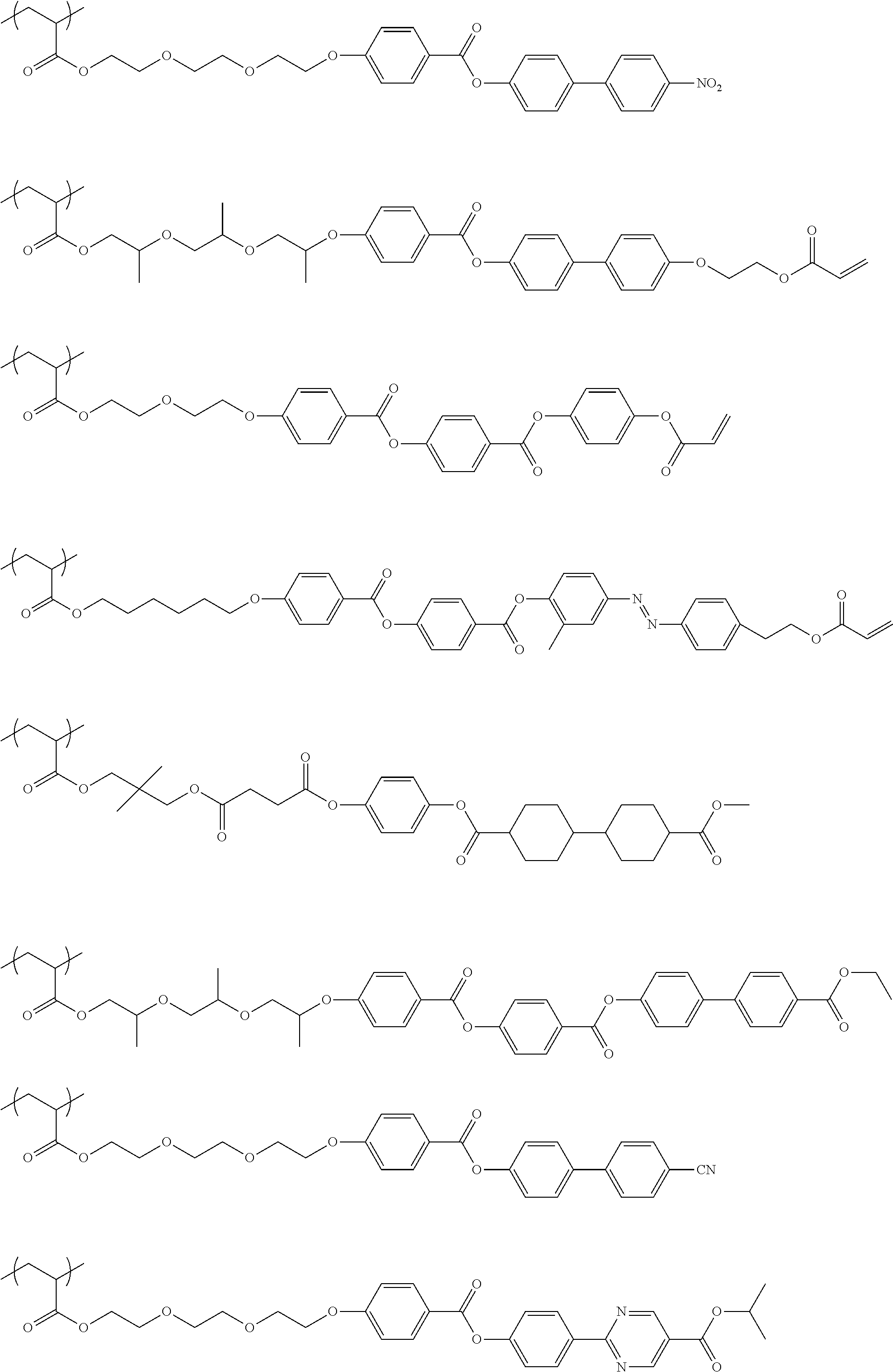

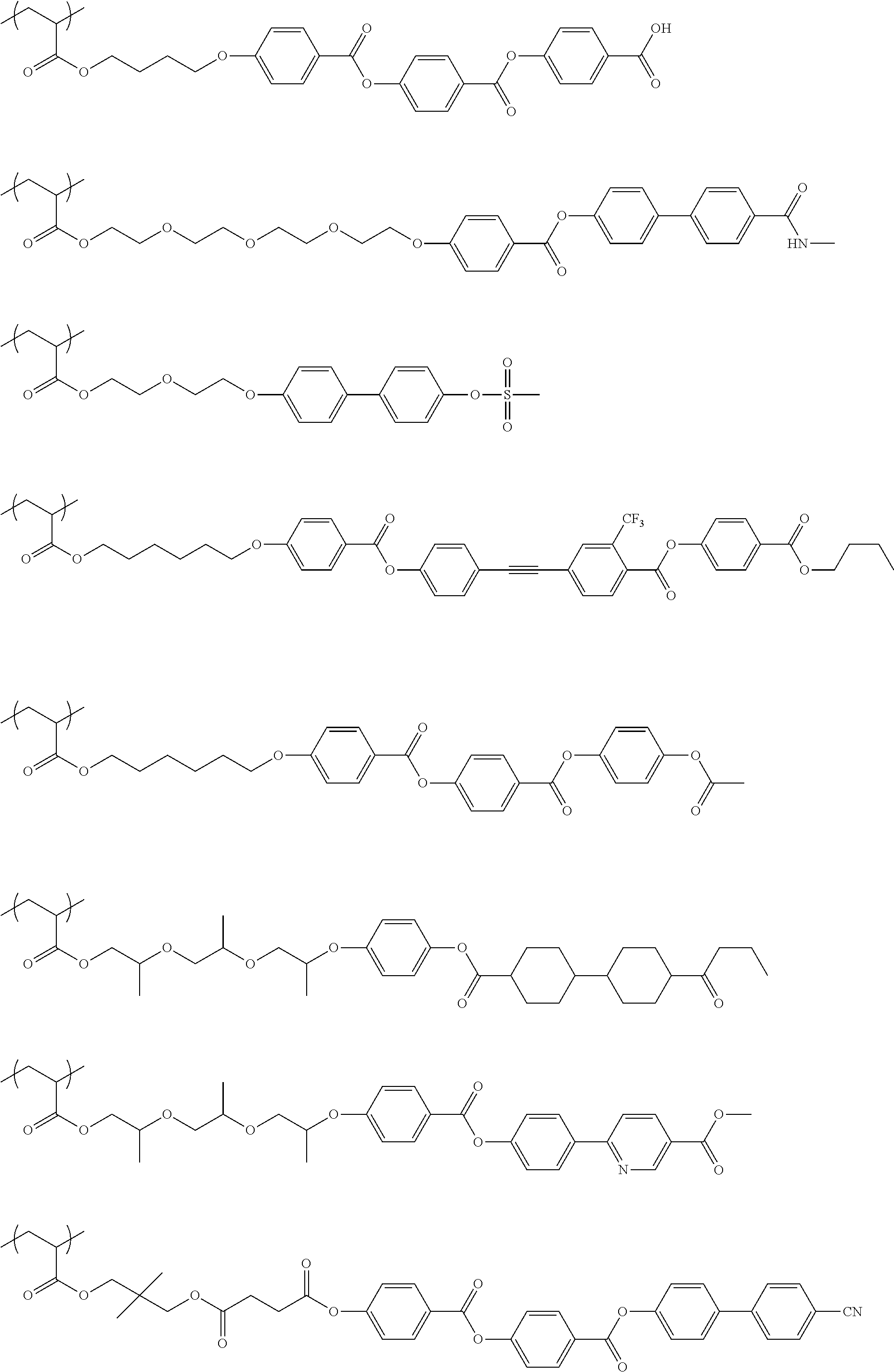

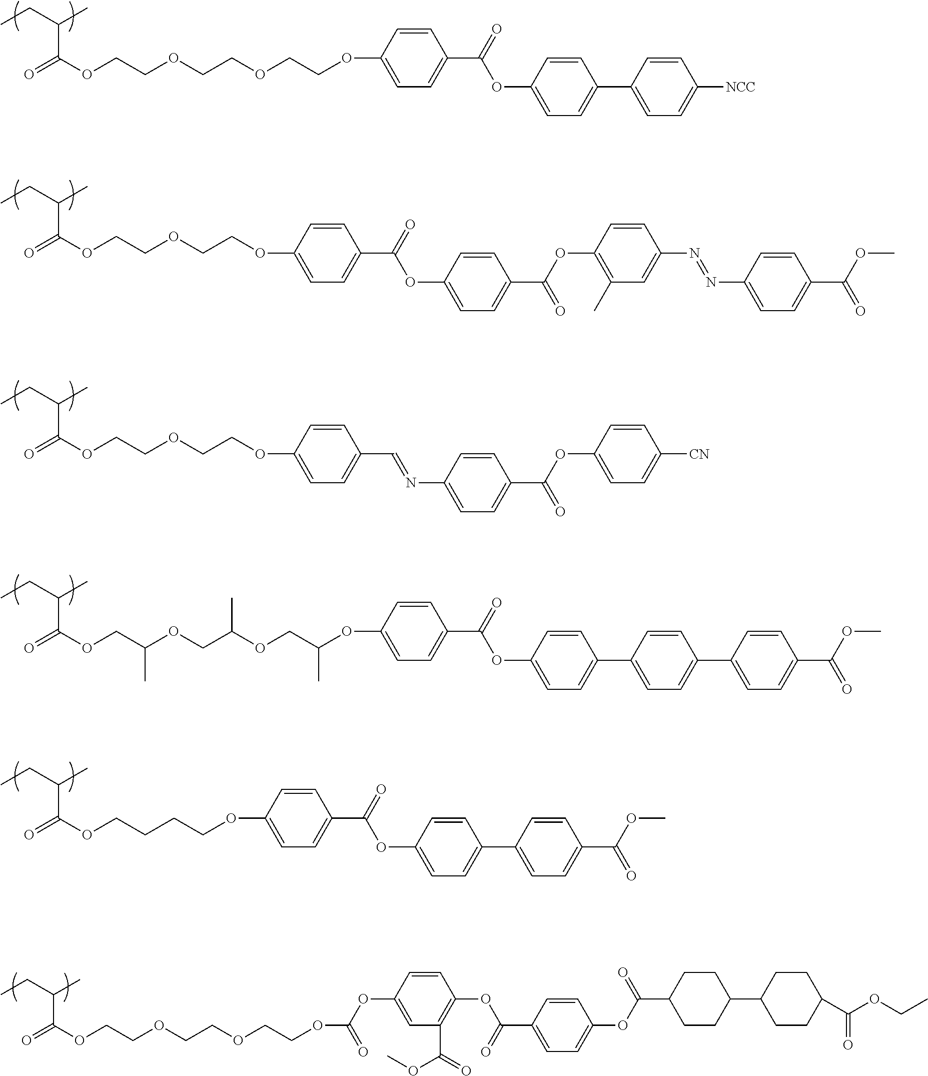

The repeating unit (22) has a mesogen group and a group which is present at the terminal of the mesogen group and has a σp value of 0 or less. In a case where the liquid crystal polymer has the repeating unit (22), the liquid crystal polymer and the specific aggregate can be uniformly aligned.

The mesogen group is a group representing a main skeleton of a liquid crystal molecule which contributes to liquid crystal formation, and is as described above for the mesogen group represented by MG1 in Formula (1), and specific examples thereof are also the same.

The above-described group is positioned at the terminal of the mesogen group and has a σp value of 0 or less. Examples of the above-described group (a group having a σp value of 0 or less) include a hydrogen atom having a σp value of 0, and a group (electron-donating group) which has a σp value of less than 0 and is represented by T22 in Formula (LCP-22) described below. Among the above-described groups, specific examples of the group (electron-donating group) having a σp value of less than 0 are the same as those for T22 in Formula (LCP-22) described below.

The σp value of the above-described group is 0 or less, and from the viewpoint that the uniformity of alignment is more excellent, it is preferably less than 0, more preferably −0.1 or less, and still more preferably −0.2 or less. The lower limit value thereof is preferably −0.9 or more and more preferably −0.7 or more.

The repeating unit (22) is not particularly limited as long as it has, at a side chain thereof, the mesogen group and the group which is present at the terminal of the mesogen group and has a σp value of 0 or less, and a repeating unit represented by Formula (LCP-22), which does not correspond to the above-described repeating unit represented by Formula (LCP-21), is preferable.

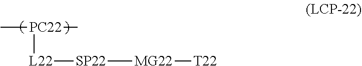

In Formula (LCP-22), PC22 represents a main chain of the repeating unit, and more specifically represents the same structure as that for PC1 in Formula (1) described above; L22 represents a single bond or a divalent linking group, and more specifically represents the same structure as that for L1 in Formula (1) described above; SP22 represents a spacer group, and more specifically represents the same structure as that for SP1 in Formula (1) described above; MG22 represents a mesogen structure, and more specifically represents the same structure as the mesogen group MG1 in Formula (1) described above; and T22 represents an electron-donating group having a Hammett's substituent constant σp value of 0 or less.

T22 represents an electron-donating group having a σp value of 0 or less (preferably less than 1).

Examples of the electron-donating group having a σp value of 0 or less include a hydroxy group, an alkyl group having 1 to 10 carbon atoms, an alkoxy group having 1 to 10 carbon atoms, and an alkylamino group having 1 to 10 carbon atoms.

In a case where the number of atoms in the main chain of T22 is 20 or less, the alignment degree of the optically anisotropic film is further improved. Here, the “main chain” of T22 means the longest molecular chain bonded to MG22, and the number of hydrogen atoms is not included in the number of atoms in the main chain of T22. For example, in a case where T22 is an n-butyl group, the number of atoms in the main chain is 4, and in a case where T22 is an sec-butyl group, the number of atoms in the main chain is 3.

Examples of the repeating unit (22) are shown below.

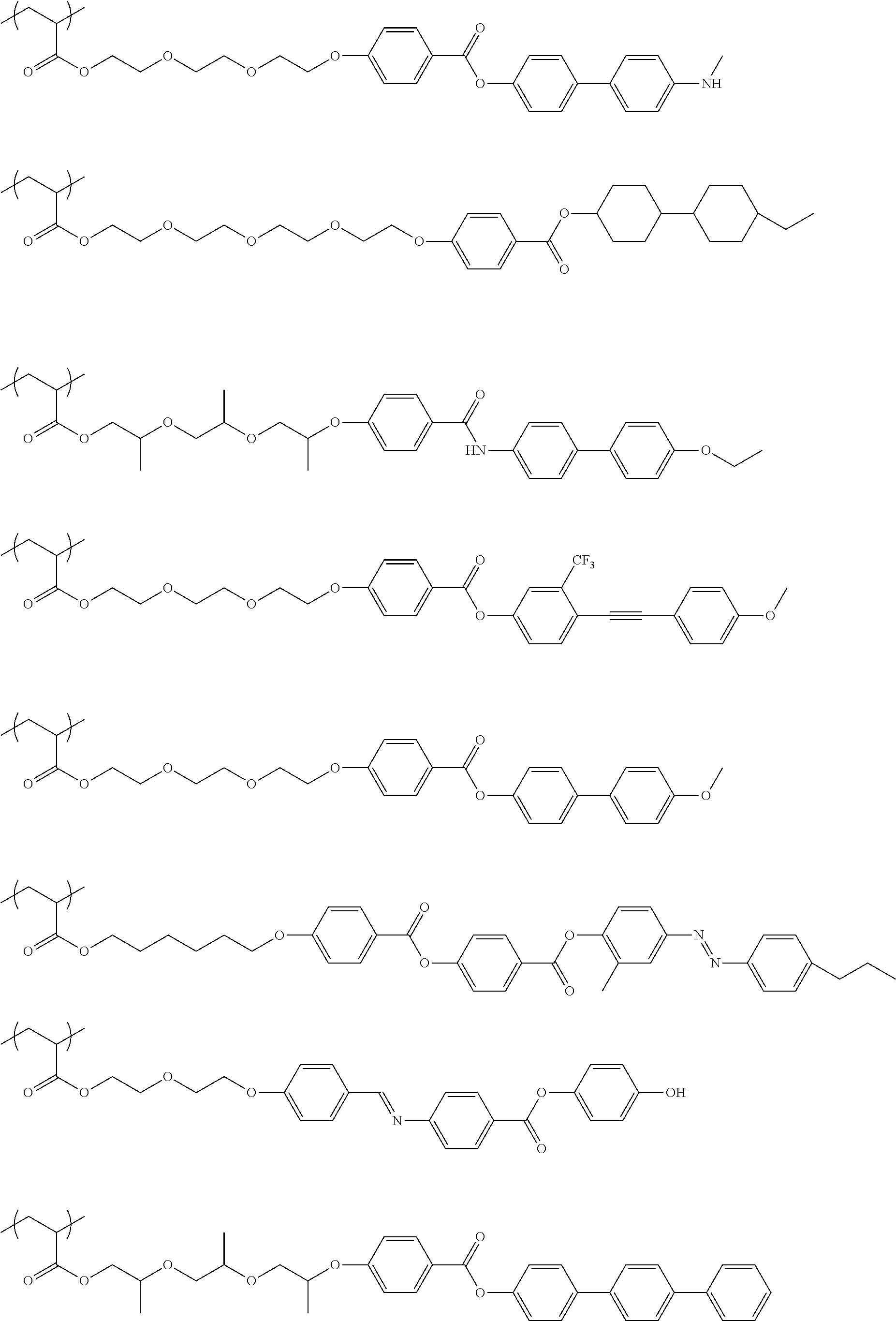

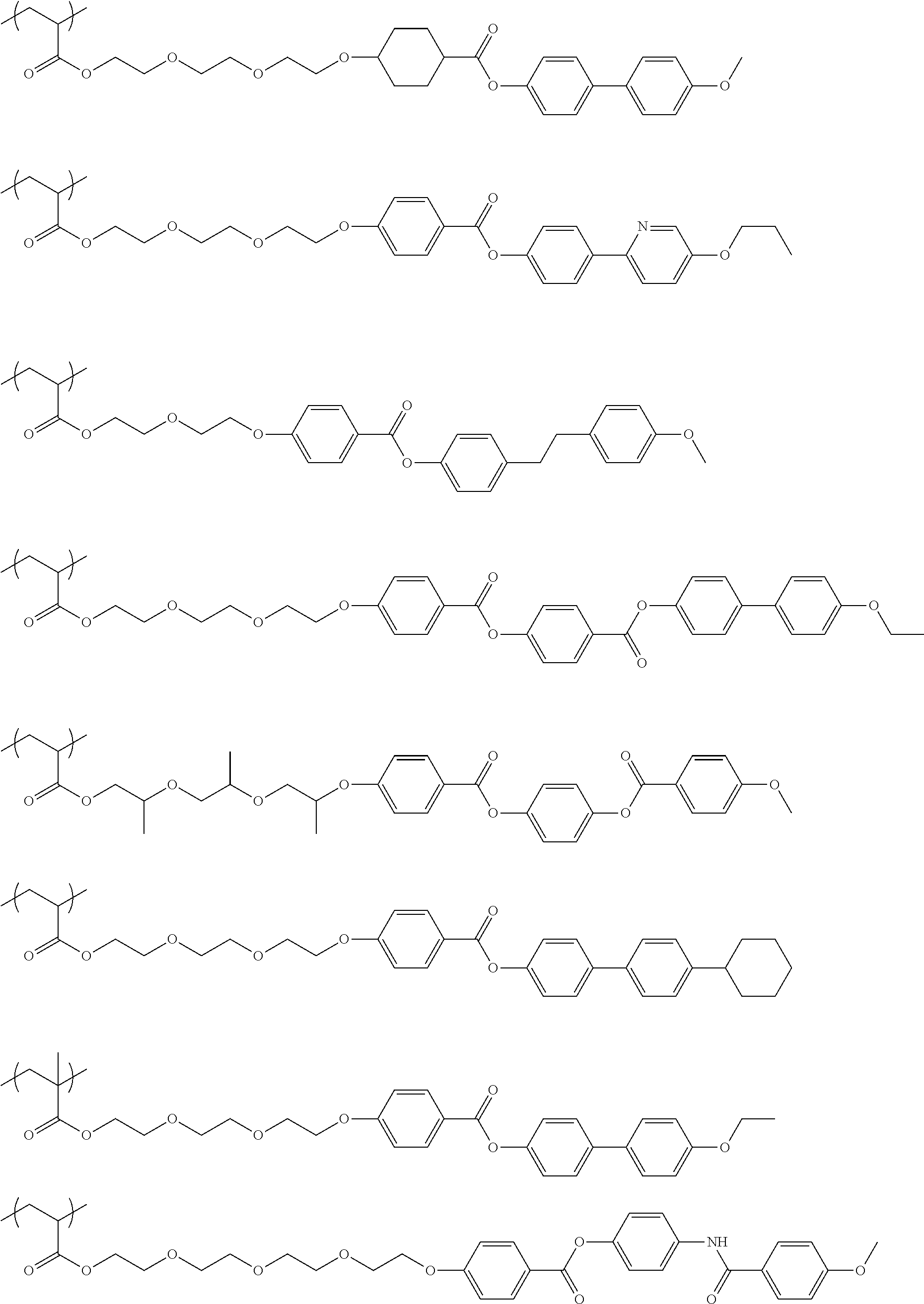

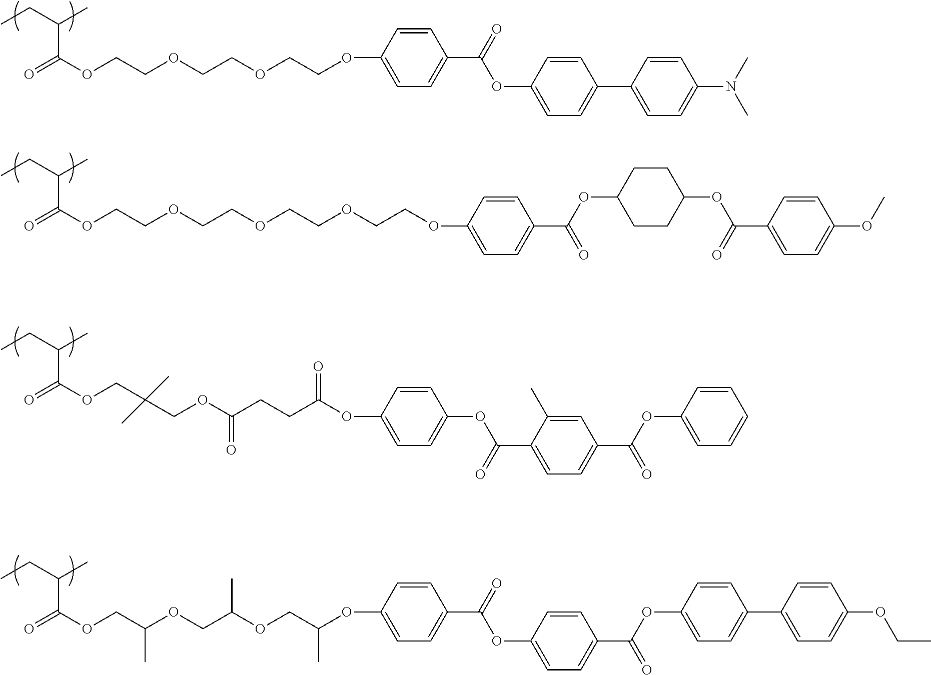

It is preferable that the structures of the repeating unit (21) and the repeating unit (22) have a part in common. It is presumed that the liquid crystals are uniformly aligned as the structures of repeating units are more similar to each other. As a result, the aligning properties of the optically anisotropic film are further improved.

Specifically, from the viewpoint of further increasing the aligning properties of the optically anisotropic film, it is preferable to satisfy at least one of a condition that SP21A of Formula (LCP-21) has the same structure as that for SP22 of Formula (LCP-22), a condition that MG21 of Formula (LCP-21) has the same structure as that for MG22 of Formula (LCP-22), or a condition that L21 of Formula (LCP-21) has the same structure as that for L22 of Formula (LCP-22); more preferable to satisfy two or more of the conditions; and particularly preferable to satisfy all the conditions.

A content of the repeating unit (22) is preferably 50% by mass or more, more preferably 55% by mass or more, and still more preferably 60% by mass or more with respect to all repeating units of the liquid crystal polymer. The upper limit value thereof is preferably 99% by mass or less and more preferably 97% by mass or less with respect to all repeating units of the liquid crystal polymer.

The liquid crystal compound may be used alone or in combination of two or more kinds thereof.

A content of the liquid crystal compound is preferably more than 50% by mass and more preferably 55% by mass or more with respect to the total mass of the optically anisotropic film. The upper limit thereof is not particularly limited, but is preferably 98% by mass or less and more preferably 95% by mass or less.

### (Polymer)

The polymer is a compound different from the above-described liquid crystal compound.

As the polymer, a known polymer can be used, and examples thereof include a polycarbonate resin, a polyolefin-based resin (particularly, a cycloolefin polymer), a cellulose-based resin, and an acrylic resin.

As will be described later, in a case where the optically anisotropic film is a stretching film, the polymer can be used for producing the stretching film.

The polymer may be used alone or in combination of two or more kinds thereof.

A content of the polymer is preferably more than 50% by mass and more preferably 55% by mass or more with respect to the total mass of the optically anisotropic film. The upper limit thereof is not particularly limited, but is preferably 98% by mass or less and more preferably 95% by mass or less.

### (Specific Aggregate)

The optically anisotropic film contains a specific aggregate.

The specific aggregate is an aggregate of organic compounds, generated by aggregation of the organic compounds.

The organic compound is a compound different from the liquid crystal compound and the polymer described above. The organic compound is not particularly limited as long as it is a compound other than the liquid crystal compound and the polymer, and a dichroic coloring agent is preferable.

The optically anisotropic film may contain an organic compound as long as the optically anisotropic film contains the specific aggregate. In other words, the optically anisotropic film may contain an organic compound which is not an aggregate.

An average value of ratios of lengths L of major axes of the specific aggregate to lengths D of minor axes of the specific aggregate (average aspect ratio, L/D) is 2.0 or more, preferably 3.5 or more and more preferably 10 or more. The upper limit thereof may be 100 or less, and is preferably 50 or less and more preferably 20 or less.

An average length L of the major axis of the specific aggregate is 10 nm or more, preferably 200 nm or more, more preferably 500 nm or more, and still more preferably 1,000 nm or more. The upper limit thereof may be 100 μm or less, and is preferably 20 μm or less and more preferably 10 μm or less.

It is preferable that an average length D of the minor axis of the specific aggregate is appropriately selected so as to be within the above-described range of L and the above-described suitable aspect ratio L/D.

The above-described L, the above-described D, and the above-described L/D can be measured by observing the specific aggregate using a scanning electron microscope (SEM).

For example, first, an image of a surface of the optically anisotropic film is acquired using SEM. Next, using image processing software “ImageJ”, an image obtained by binarizing the brightness of the acquired image is created. Among the plurality of high-brightness regions of the created binarized image, a region having an area equal to or more than an area of a circle having a diameter of 50 nm (1963 nm²) is extracted as the specific aggregate. The binarization of the brightness of the surface SEM observation image is performed by creating a brightness histogram of the SEM observation image and extracting the brightness at which a frequency is the highest in the created brightness histogram. As a threshold value for the binarization, for example, a brightness 1.2 times the brightness at which the frequency is the highest is used. Next, using the above-described image processing software, each specific aggregate extracted is approximated to an ellipse, and a length of a major axis of the approximated ellipse is measured as the length L of the major axis of the specific aggregate, and a length of a minor axis of the approximated ellipse is measured as the length D of the minor axis of the specific aggregate.

Specifically, the measurement is performed at three locations in a 13.58 μm² region in which the measurements do not overlap with each other; D, L, and L/D of five specific aggregates are calculated at each location; and the calculated 15 L/D's are arithmetically averaged to calculate the average value of ratios described above, the calculated 15 L's are arithmetically averaged to calculate the average length L of the major axis, and the calculated 15 D's are arithmetically averaged to calculate the average length D of the minor axis.

The optically anisotropic film to be measured may be brought into contact with a solution before the measurement, as necessary. In a case where the above-described treatment is performed, since components other than the specific aggregate, contained in the optically anisotropic film (for example, the liquid crystal compound or the like), can be removed, the above-described measurement is facilitated. Examples of the above-described solution include a sodium chloride aqueous solution.

The specific aggregate is preferably a J-aggregate, and more preferably a J-aggregate of dichroic coloring agents.

The J-aggregate is an aggregate of organic compounds (for example, dichroic coloring agents and the like). More specifically, the J-aggregate refers to a state in which molecules of the organic compound are associated with each other with a constant deviation angle (slip angle). The J-aggregate has an absorption band with a narrow half-width and a high absorption light absorption coefficient on a long wavelength side as compared with a case of a single organic compound molecule in a solution state. Hereinafter, the sharpened absorption band is referred to as a J-band. For the J band, there is a detailed description in the literature (for example, Photographic Science and Engineering Vol. 18, No. 323 to 335 (1974)). Whether or not it is a J-aggregate can be easily determined by measuring its maximal absorption wavelength.

An absorption peak of the J-band is shifted to a long wavelength side with respect to the absorption peak of a single organic compound molecule, and a difference between the wavelength of the absorption peak of the J-band and the wavelength of the absorption peak of the single organic compound molecule is preferably 10 to 300 nm and more preferably 30 to 250 nm.

In a case where an absorption spectrum of the specific aggregate in an infrared region is subjected to waveform separation, it is preferable that the absorption spectrum is composed of a plurality of peaks derived from the J-aggregate.

The number of the above-described peaks (the number of maximal values) derived from the J-aggregate in a case where the peaks are subjected to waveform separation is preferably 2 or more and more preferably 3 or more. The upper limit thereof is preferably 10 or less.

In a case where the above-described absorption spectrum of the specific aggregate in the infrared region is subjected to waveform separation, and the absorption spectrum is composed of a plurality of peaks derived from the J-aggregate, it is presumed that the specific aggregate is tubular.

Whether or not the above-described configuration is adopted can be determined, for example, by the following method.

In a case where the absorbance of the specific aggregate at the maximal absorption wavelength in the infrared region is measured and standardized to be 1.0, fitting by a linear combination of a Lorentz function is performed on the obtained absorption spectrum for a range in which the absorbance is 0.05 or more.

Next, the above-described fitting is repeated until the number of Lorentz functions to be used is sequentially increased as a coefficient of determination R² of being 0.98 or more, in a case where the correlation analysis between the actually measured value and the simulation value is performed in 1 nm increments.

From the obtained plurality of absorption spectra, a spectrum of an organic compound having a maximal absorption wavelength in a range of maximal absorption wavelength±10 nm in an infrared region is excluded in order to exclude a peak derived from an organic compound constituting the specific aggregate.

The above-described configuration can be determined by reading the number of peaks (the number of maximal values) from the absorption spectrum after the exclusion.

The fitting and the correlation analysis described above are performed using, for example, a spreadsheet software (Microsoft Excel).

It is preferable that the specific aggregate does not exhibit absorption in a visible light region (wavelength range of 400 to 700 nm).

Specifically, an average transmittance in the visible light region is 90% or more. The above-described average transmittance is preferably 95% or more. The upper limit thereof may be less than 100%.

The average transmittance can be measured by the same method as the average transmittance of the liquid crystal compound.

The specific aggregate preferably has a maximal absorption wavelength in a wavelength range of 700 to 2,500 nm. That is, the specific aggregate preferably has an absorption in an infrared region.

The specific aggregate may have a plurality of maximal absorption wavelengths in the wavelength range of 700 to 2,500 nm.

In a case where the specific aggregate is a J-aggregate, it is preferable that a maximal absorption wavelength of the J-aggregate is exhibited in the wavelength range of 700 to 2,500 nm.

As will be described later, the maximal absorption wavelength of the specific aggregate in the above-described wavelength range of 700 to 2,500 nm preferably corresponds to the maximal absorption wavelength of the optically anisotropic film in the wavelength range of 700 to 2,500 nm.

The dichroic coloring agent means an organic compound having different absorbances depending on the direction.

The dichroic coloring agent may exhibit liquid crystallinity (for example, lyotropic liquid crystallinity, thermotropic liquid crystallinity, and the like), or may not exhibit liquid crystallinity.

In a case where the dichroic coloring agent exhibits the liquid crystallinity, any of nematic properties, smectic properties, or columnar properties may be exhibited.

The dichroic coloring agent preferably has a maximal absorption wavelength in a wavelength range of 700 to 2,500 nm.

As a measuring method of the above-described maximal absorption wavelength of the dichroic coloring agent, using a solution prepared by dissolving an object to be measured (5 to 50 mg) in a solution (for example, water, methanol, dimethyl sulfoxide, and the like) (1,000 mL) which dissolves the object to be measured, an absorption spectrum is measured using a spectrophotometer (MPC-3100 (manufactured by Shimadzu Corporation)), and the maximal absorption wavelength is read from the obtained absorption spectrum.

The dichroic coloring agent preferably has a hydrophilic group.

Examples of the hydrophilic group include the hydrophilic group which can be included in the liquid crystal compound described above.

A type of the dichroic coloring agent is not particularly limited, and examples thereof include known materials.

Examples of the dichroic coloring agent include phthalocyanine-based coloring agents, naphthalocyanine-based coloring agents, metal complex-based coloring agents, boron complex-based coloring agents, cyanine-based coloring agents, oxonol-based coloring agents, squarylium-based coloring agents, rylene-based coloring agents, diimmonium-based coloring agents, diphenylamine-based coloring agents, triphenylamine-based coloring agents, quinone-based coloring agents, and azo-based coloring agents. In general, these coloring agents extend an absorption wavelength to a long wavelength side by extending the existing π-conjugated system, and exhibit a wide variety of absorption wavelengths depending on their structure.

Among these, a phthalocyanine-based coloring agent having a hydrophilic group, a naphthalocyanine-based coloring agent having a hydrophilic group, a metal complex-based coloring agent having a hydrophilic group, a boron complex-based coloring agent having a hydrophilic group, a cyanine-based coloring agent having a hydrophilic group, an oxonol-based coloring agent having a hydrophilic group, a squarylium-based coloring agent having a hydrophilic group, a rylene-based coloring agent having a hydrophilic group, a diimonium-based coloring agent having a hydrophilic group, a diphenylamines-based coloring agent having a hydrophilic group, a triphenylamines-based coloring agent having a hydrophilic group, a quinone-based coloring agent having a hydrophilic group, or an azo-based coloring agent having a hydrophilic group is preferable. Examples of the hydrophilic group included in the coloring agent exemplified above include the hydrophilic group which can be included in the liquid crystal compound described above.

The phthalocyanine-based coloring agent and the naphthalocyanine-based coloring agent are coloring agents having a planar structure and a wide π-conjugated plane.

The phthalocyanine-based coloring agent preferably has a structure represented by Formula (1A).

The naphthalocyanine-based coloring agent preferably has a structure represented by Formula (1B).

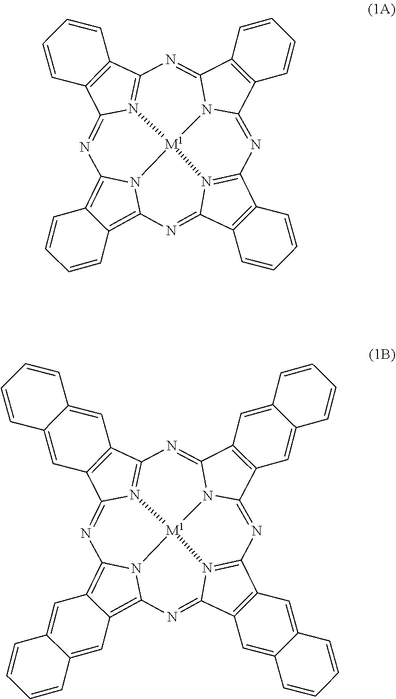

In Formula (1A) and Formula (1B), M¹ represents a hydrogen atom, a metal atom, a metal oxide, a metal hydroxide, or a metal halide.

Examples of the metal atom include Li, Na, K, Mg, Ti, Zr, V, Nb, Ta, Cr, Mo, W, Mn, Fe, Co, Ni, Ru, Rh, Pd, Os, Ir, Pt, Cu, Ag, Au, Zn, Cd, Hg, Al, Ga, In, Si, Ge, Sn, Pb, Sb, and Bi.

Examples of the metal oxide include VO, GeO, and TiO.

Examples of the metal hydroxide include Si(OH)₂, Cr(OH)₂, Sn(OH)₂, and AlOH.

Examples of the metal halide include SiCl₂, VCl, VCl₂, VOCl, FeCl, GaCl, ZrCl, and AlCl.

Among these, a metal atom such as Fe, Co, Cu, Ni, Zn, Al, and V, a metal oxide such as VO, or a metal hydroxide such as AlOH is preferable, and a metal oxide such as VO is more preferable.

The phthalocyanine-based coloring agent is preferably a compound represented by Formula (1A-1).

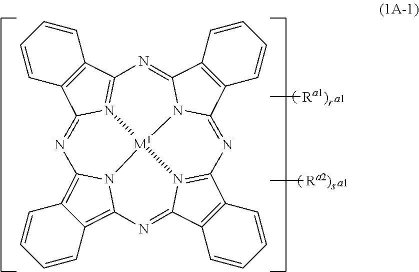

In Formula (1A-1), R^{a1} and R^{a2} each independently represent a substituent.

Examples of the above-described substituent include groups exemplified by the substituent W described later.

It is preferable that R^{a1} represents a substituent including a hydrophilic group (hereinafter, also referred to as “specific substituent”), and R^{a2} represents a substituent not including a hydrophilic group.

The hydrophilic group included in the specific substituent is as described above.

The specific substituent is preferably a group represented by Formula (Z).

*-L^{a1}-(R^{a11})_{q} Formula (Z)

In Formula (Z), * represents a bonding position.

R^{a11} represents a hydrophilic group. Examples of the hydrophilic group include the hydrophilic group which can be included in the liquid crystal compound described above.

In Formula (Z), in a case where q is 1, L^{a1} represents a single bond or a divalent linking group, and in a case where q is 2 or more, L^{a1} represents a (q+1)-valent linking group.

Examples of the divalent linking group include a divalent hydrocarbon group (for example, a divalent aliphatic hydrocarbon group such as an alkylene group (preferably having 1 to 10 carbon atoms and more preferably having 1 to 5 carbon atoms), an alkenylene group (preferably having 2 to 10 carbon atoms and more preferably having 2 to 5 carbon atoms), and an alkynylene group (preferably having 2 to 10 carbon atoms and more preferably having 2 to 5 carbon atoms), and a divalent aromatic hydrocarbon ring group such as an arylene group), a divalent heterocyclic group, —O—, —S—, —NH—, —N(Q)-, —CO—, and a group obtained by combining these groups (for example, —O-divalent hydrocarbon group-, —(O-divalent hydrocarbon group)ₘ—O— (m represents an integer of 1 or more), -divalent hydrocarbon group-O—CO—, and the like). Q represents a hydrogen atom or an alkyl group.

In a case where q is 2 or more, examples of the (q+1)-valent linking group represented by L^{a1} include a trivalent linking group (q=2) and a tetravalent linking group (q=3).

Examples of the trivalent linking group include a residue formed by removing three hydrogen atoms from a hydrocarbon, a group represented by —N<, a residue formed by removing three hydrogen atoms from a heterocyclic compound, and a group obtained by combining the residue and the above-described divalent linking group.

Examples of the tetravalent linking group include a residue formed by removing four hydrogen atoms from a hydrocarbon, a residue formed by removing four hydrogen atoms from a heterocyclic compound, and a group obtained by combining the residue and the above-described divalent linking group.

q represents an integer of 1 or more, and is preferably an integer of 1 to 4, more preferably 1 or 2, and still more preferably 1.

Examples of the above-described substituent not having a hydrophilic group, represented by R^{a2}, include an alkyl group, an aryl group, and a heteroaryl group.

r^{a1} represents an integer of 1 or more, and is preferably an integer of 1 to 12 and more preferably an integer of 1 to 4.

s^{a1} represents an integer of 0 or more, and is preferably an integer of 0 to 4 and more preferably 0.

The naphthalocyanine-based coloring agent is preferably a compound represented by Formula (1B-1).

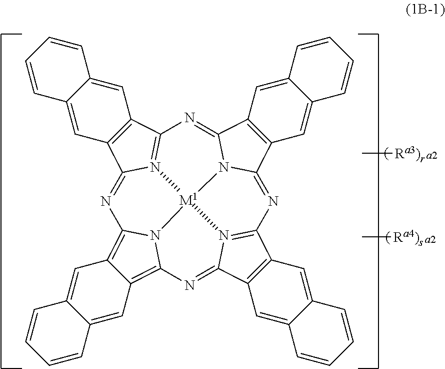

In Formula (1B-1), R^{a3} and R^{a4} each independently represent a substituent.

Examples of the above-described substituent include groups exemplified by the substituent W described later.

It is preferable that R^{a3} represents the specific substituent, and R^{a4} represents a substituent not including a hydrophilic group.

The hydrophilic group included in the specific substituent is as described above.

The specific substituent represented by R^{a3} has the same meaning as the specific substituent represented by R^{a1}.

The substituent not including a hydrophilic group, represented by R^{a4}, has the same meaning as the substituent not including a hydrophilic group, represented by R^{a2}.

r^{a2} represents an integer of 1 or more, and is preferably an integer of 1 to 12 and more preferably an integer of 1 to 4.

s^{a2} represents an integer of 0 or more, and is preferably an integer of 0 to 4 and more preferably 0.

As the phthalocyanine-based coloring agent, the following compound example 1 is preferable.

### Compound Example 1

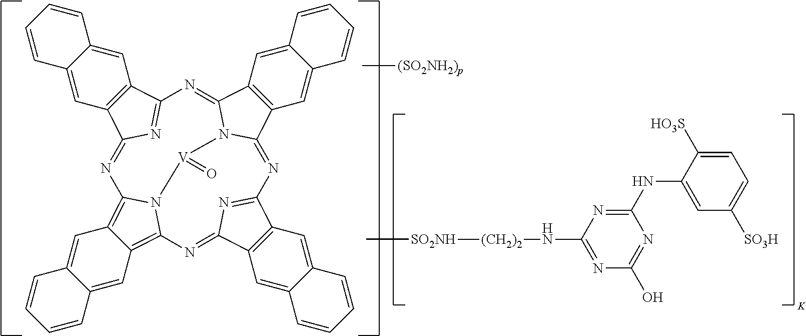

In the formula, p and k each independently represent an integer of 0 to 12, and the sum of p and k is an integer of 1 to 12. Among these, it is preferable that p is an integer of 1 to 4 and k is 0.

The quinone-based coloring agent is a coloring agent having a wide range of absorption.

The quinone-based coloring agent preferably has a structure represented by Formula (2).

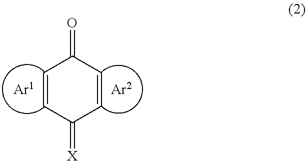

In Formula (2), X represents an oxygen atom or ═NR^{b}. R^{b} represents a hydrogen atom or a substituent. Examples of the substituent represented by R^{b} include groups exemplified by a substituent W described later.

Ar¹ and Ar² each independently represent an aromatic ring or a heterocyclic ring, and from the viewpoint of extending the absorption wavelength to a long wavelength side, a heterocyclic ring is preferable.

Examples of the quinone-based coloring agent having a hydrophilic group include indanthrene coloring agents described in JP2006-508034A.

The quinone-based coloring agent is preferably a compound represented by Formula (2-1).

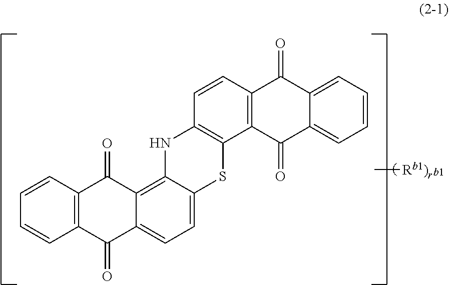

In Formula (2-1), R^{b1}'s each independently represent a substituent.

Examples of the above-described substituent include groups exemplified by the substituent W described later; and the specific substituent is preferable, and the specific substituent in which q in Formula (Z) is 1 is more preferable.

r^{b1} represents an integer of 1 to 12, and is preferably an integer of 1 to 4.

As the quinone-based coloring agent, the following compound example 2 is preferable.

### Compound Example 2

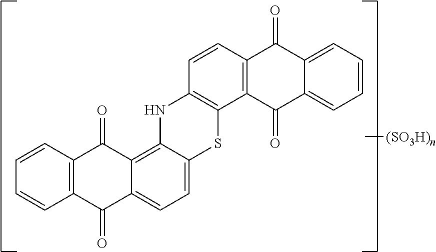

In the formula, n represents an integer of 1 to 12, and each sulfonic acid may be in a liberate form, in a salt for, or may include both the liberate form and the salt form in arbitrary ratio.

The cyanine-based coloring agent is a coloring agent having strong absorption in the infrared region.

The cyanine-based coloring agent is preferably a compound represented by Formula (3) or a compound represented by Formula (4).

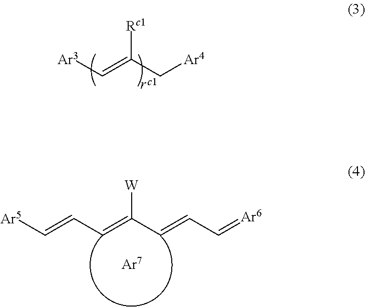

In Formula (3), Ar³ and Ar⁴ each independently represent a heterocyclic group which may have the specific substituent, and R^{c1} represents a hydrogen atom or a substituent.

It is preferable that at least one of Ar³ or Ar⁴ represents a heterocyclic group having the specific substituent.

Examples of a heterocyclic ring constituting the heterocyclic group include an indolenine ring, a benzoindolenine ring, an imidazole ring, a benzimidazole ring, a naphthimidazole ring, thiazole ring, a benzothiazole ring, a naphthothiazole ring, a thiazoline ring, an oxazole ring, a benzoxazole ring, a naphthoxazole ring, an oxazoline ring, a selenazole ring, a benzoselenazole ring, a naphthoselenazole ring, and a quinoline ring; and an indolenine ring, a benzoindolenine ring, a benzothiazole ring, or a naphthothiazole ring is preferable.

The specific substituent may be substituted on a heteroatom in the heterocyclic ring, or may be substituted on a carbon atom in the heterocyclic ring.

The heterocyclic group may have one or two or more (for example, two or three) specific substituents.

r^{c1} represents an integer of 1 to 7, and is preferably an integer of 3 to 5.

The type of the substituent represented by R^{c1} is not particularly limited, examples thereof include known substituents, and an alkyl group which may have a substituent, an aryl group which may have a substituent, or a heteroaryl group which may have a substituent is preferable.

Examples of the substituent which may be included in the alkyl group, the aryl group, or the heteroaryl group include an alkyl group, an alkenyl group, an alkynyl group, an aryl group, an alkoxy group, an aryloxy group, an aromatic heterocyclic oxy group, an acyl group, an alkoxycarbonyl group, an aryloxycarbonyl group, an acyloxy group, an acylamino group, an alkoxycarbonylamino group, an aryloxycarbonylamino group, a sulfamoyl group, a carbamoyl group, an alkylthio group, an arylthio group, an aromatic heterocyclicthio group, a ureide group, a halogen atom, a cyano group, a nitro group, a heterocyclic group (for example, a heteroaryl group), a silyl group, and a group obtained by combining these groups (hereinafter, these groups are also collectively referred to as “substituent W”). The above-described substituent may be further substituted with the substituent W.

In Formula (4), Ar⁵ and Ar⁶ each independently represent a heterocyclic group which may have the specific substituent; Ar⁷ represents a cyclic skeleton having 5 to 7 carbon atoms; and W represents a hydrogen atom, a halogen atom, a methyl group, a phenyl group which may have a substituent, a benzyl group which may have a substituent, a pyridyl group, a morpholyl group, a piperidyl group, a phenylamino group which may have a substituent, a phenoxy group which may have a substituent, an alkylthio group which may have a substituent, or a phenylthio group which may have a substituent.

It is preferable that at least one of Ar⁵ or Ar⁶ represents a heterocyclic group having the specific substituent.

Examples of a heterocyclic ring constituting the heterocyclic group include an indolenine ring, a benzoindolenine ring, an imidazole ring, a benzimidazole ring, a naphthimidazole ring, thiazole ring, a benzothiazole ring, a naphthothiazole ring, a thiazoline ring, an oxazole ring, a benzoxazole ring, a naphthoxazole ring, an oxazoline ring, a selenazole ring, a benzoselenazole ring, a naphthoselenazole ring, and a quinoline ring; and an indolenine ring, a benzoindolenine ring, a benzothiazole ring, or a naphthothiazole ring is preferable.

Examples of the substituent which may be included in the phenyl group, the benzyl group, the phenylamino group, the phenoxy group, the alkylthio group, or the phenylthio group represented by W include the groups exemplified by the substituent W described above, a hydrophilic group, and the specific substituent.

The number of carbon atoms in the alkylthio group represented by W is not particularly limited, but is preferably 1 to 5 and more preferably 1 to 3.

The compound represented by Formula (4) is preferably an intramolecular salt type having a cation and an anion in one molecule or an intermolecular salt type; and examples of the intermolecular salt type include a halide salt, perchlorate, fluoroantimonate, fluorophosphate, fluoroborate, trifluoromethanesulfonate, bis(trifluoromethane)sulfonic acid imide salt, and organic salts of naphthalene sulfonic acid or the like.

Specific examples thereof include indocyanine green and water-soluble coloring agents described in JP1988-033477A (JP-S63-033477A).

The compound represented by Formula (4) is preferably a compound represented by Formula (4-1).

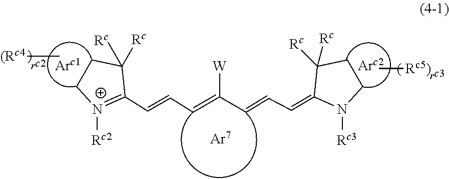

In Formula (4-1), R^{c2} to R^{c5} each independently represent a hydrogen atom or a substituent. At least one of R^{c2} to R^{c5} preferably represents a substituent having —SO₃⁻ (for example, an alkyl group having —SO₃⁻; the number of carbon atoms in the alkyl group is preferably 1 to 10), a substituent having —COO⁻ (for example, an alkyl group having —COO⁻; the number of carbon atoms in the alkyl group is preferably 1 to 10), —SO₃⁻, or —COO⁻.

R^{c}'s each independently represent a hydrogen atom or a substituent. Examples of the substituent represented by R^{c} include the groups exemplified by the substituent W, and an alkyl group is preferable. The number of carbon atoms in the above-described alkyl group is preferably 1 to 5.

Ar^{c1} and Ar^{c2} each independently represent an aromatic hydrocarbon ring (for example, a benzene ring or a naphthalene ring); Ar⁷ represents a cyclic skeleton having 5 to 7 carbon atoms; W represents a hydrogen atom, a halogen atom, a methyl group, a phenyl group which may have a substituent, a benzyl group which may have a substituent, a pyridyl group, a morpholyl group, a piperidyl group, a phenylamino group which may have a substituent, a phenoxy group which may have a substituent, an alkylthio group which may have a substituent, or a phenylthio group which may have a substituent; r^{c2} represents an integer of 1 to 3; and r^{c3} represents an integer of 1 to 3.

Examples of the substituent represented by R^{c2} to R^{c5} include the groups exemplified by the substituent W, and the specific substituent.

Examples of the substituent which may be included in the phenyl group, the benzyl group, the phenylamino group, the phenoxy group, the alkylthio group, or the phenylthio group represented by W include the groups exemplified by the substituent W, and the specific substituent.

Examples of the compound represented by Formula (3) and the compound represented by Formula (4) include compound examples 3 to 6.

### Compound Example 3

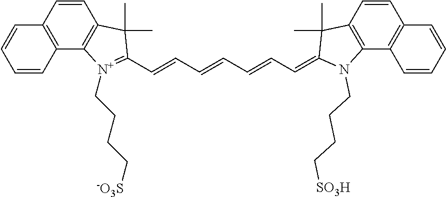

### Compound Example 4

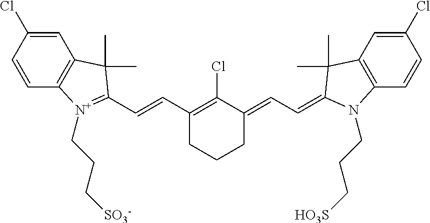

### Compound Example 5

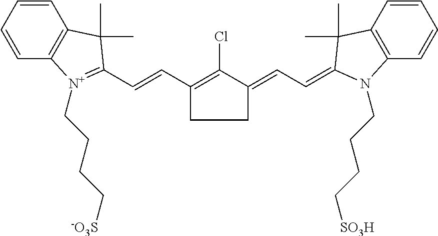

### Compound Example 6

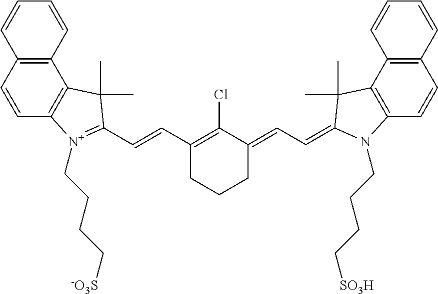

The squarylium-based coloring agent is a coloring agent having a squaric acid in a central skeleton.

The squarylium-based coloring agent is preferably a compound represented by Formula (5).

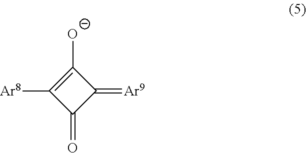

In Formula (5), Ar⁸ and Ar⁹ each independently represent a heterocyclic group which may have the specific substituent. Ar⁸ and Ar⁹ are preferably the above-described heterocyclic ring represented by Ar⁶.

The compound represented by Formula (5) also has an intramolecular salt type or an intermolecular salt type, and has a salt form same as the cyanine-based coloring agent.

As the squarylium-based coloring agent, a compound represented by Formula (5-1) or a compound represented by Formula (5-2) is preferable.

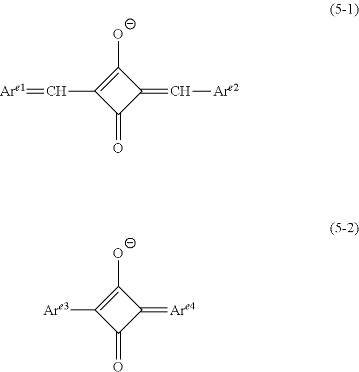

In Formula (5-1), Ar^{e1} represents a heterocyclic group which may have the specific substituent. Ar^{e2} represents a heterocyclic group including N⁺, which may have the specific substituent. It is preferable that at least one of the heterocyclic group represented by Ar^{e1} or the heterocyclic group represented by Ar^{e2} has the specific substituent.

In Formula (5-2), Ar^{e3} represents a heterocyclic group which may have the specific substituent. Ar^{e4} represents a heterocyclic group including N⁺, which may have the specific substituent. It is preferable that at least one of the heterocyclic group represented by Ar^{e3} or the heterocyclic group represented by Ar^{e4} has the specific substituent.

The azo-based coloring agent is a coloring agent absorbing a visible light region and is mainly used for a water-soluble ink. However, there also commercially available azo-based coloring agents which can absorb light in the infrared region because their absorption band has been widened.

Examples of the azo-based coloring agent include C. I. Acid Black 2 (manufactured by Orient Chemical Industries Co., Ltd.) and C. I. Direct Black 19 (manufactured by Sigma-Aldrich Corporation) described in JP5979728B.

In addition, the azo-based coloring agent can also form a complex with a metal atom. Examples of the complex including the azo-based coloring agent include a compound represented by Formula (6).

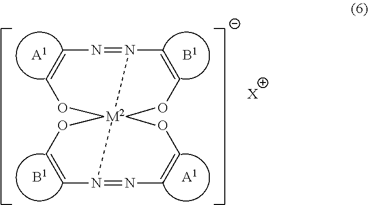

In Formula (6), M² represents a metal atom, and examples thereof include cobalt and nickel.

A¹ and B¹ each independently represent an aromatic ring which may have the specific substituent.

It is preferable that at least one of A¹ or B¹ represents an aromatic ring having the specific substituent.

Examples of the aromatic ring include a benzene ring and a naphthalene ring.

X⁺ represents a cation. Examples of the cation include H⁺, an alkali metal cation, and an ammonium cation.

Examples of the complex including the azo-based coloring agent include coloring agents described in JP1984-011385A (JP-S59-011385A).

Examples of the metal complex-based coloring agent include a compound represented by Formula (7) and a compound represented by Formula (8).

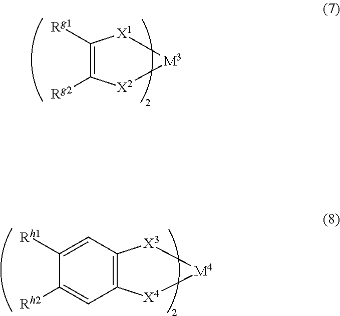

In Formula (7), M³ represents a metal atom. R^{g1} and R^{g2} each independently represent a hydrogen atom or a substituent. X¹ and X² each independently represent an oxygen atom, a sulfur atom, or —NR^{g3}—. R^{g3} represents a hydrogen atom, an alkyl group, or an aryl group.

It is preferable that at least one of R^{g1} or R^{g2} represents the specific substituent.

Examples of the metal atom represented by M³ include Pd, Ni, Co, and Cu, and Ni is preferable.

The type of the substituent represented by R^{g1} and R^{g2} is not particularly limited, and examples thereof include the groups exemplified by the substituent W described above and the specific substituent.

In Formula (8), M⁴ represents a metal atom, R^{h1} and R^{h2} each independently represent a hydrogen atom or a substituent, and X³ and X⁴ each independently represent an oxygen atom, a sulfur atom, or —NR^{h3}—. R^{h3} represents a hydrogen atom, an alkyl group, or an aryl group.

It is preferable that at least one of R^{h1} or R^{h2} represents the specific substituent.

Examples of the metal atom represented by M⁴ include Pd, Ni, Co, and Cu, and Ni is preferable.

The type of the substituent represented by R^{h1} and R^{h2} is not particularly limited, and examples thereof include the groups exemplified by the substituent W described above and the specific substituent.

Examples of the boron complex-based coloring agent include a compound represented by Formula (9).

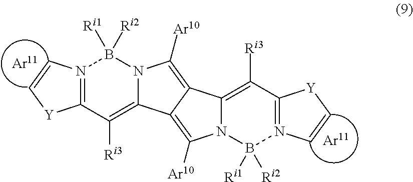

In Formula (9), Rⁱ¹ and Rⁱ² each independently represent a hydrogen atom, an alkyl group, or a phenyl group; Rⁱ³'s each independently represent an electron withdrawing group; Ar¹⁰'s each independently represent an aryl group which may have a substituent; at least one of two Ar¹⁰'s represents an aryl group having a substituent; Ar¹¹'s each independently represent an aromatic hydrocarbon ring or an aromatic heterocyclic ring, which may have a substituent; and Y represents a sulfur atom or an oxygen atom.

The electron withdrawing group represented by Rⁱ³ is not particularly limited, and represents a substituent having a positive Hammett's sigma para value (σp value); and examples thereof include a cyano group, an acyl group, an alkyloxycarbonyl group, an aryloxycarbonyl group, a sulfamoyl group, a sulfinyl group, and a heterocyclic group.

These electron withdrawing groups may be further substituted.

The Hammett's substituent constant σp value will be described. The Hammett's rule is an empirical rule advocated by L. P. Hammett in 1935 so as to quantitatively discuss the effect of substituent on the reaction or equilibrium of benzene derivatives and its propriety is widely admitted at present. Substituent constants obtained by the Hammett's rule are an σp value and an σm value, and these values can be found in many general books. For example, it is specifically described in Chem. Rev., 1991, vol. 91, pages 165 to 195. In the present invention, a substituent having the Hammett's substituent constant σp value of 0.20 or more is preferable as the electron withdrawing group. The σp value is preferably 0.25 or more, more preferably 0.30 or more, and still more preferably 0.35 or more. The upper limit thereof is not particularly limited, but is preferably 0.80 or less.

Specific examples thereof include a cyano group (0.66), a carboxyl group (—COOH: 0.45), an alkoxycarbonyl group (—COOMe: 0.45), an aryloxycarbonyl group (—COOPh: 0.44), a carbamoyl group (—CONH₂: 0.36), an alkylcarbonyl group (—COMe: 0.50), an arylcarbonyl group (—COPh: 0.43), an alkylsulfonyl group (—SO₂Me: 0.72), and an arylsulfonyl group (—SO₂Ph: 0.68).

The aryl group which may have a substituent represented by Ar¹⁰ is preferably a phenyl group which may have a substituent.

Examples of the above-described substituent include the groups exemplified by the substituent W described above and the specific substituent (preferably, an aspect of q=1).

The aromatic hydrocarbon ring in the aromatic hydrocarbon ring which may have a substituent, represented by Ar¹¹, is preferably a benzene ring or a naphthalene ring.

Examples of the substituent which may be included in the aromatic hydrocarbon ring and the aromatic heterocyclic ring represented by Ar¹¹ include the groups exemplified by the substituent W described above and the specific substituent.

The diimonium-based coloring agent is a coloring agent having absorption on a relatively long wavelength side (wavelength range of 950 to 1,100 nm) even in a near infrared region, and is preferably a compound represented by Formula (10).

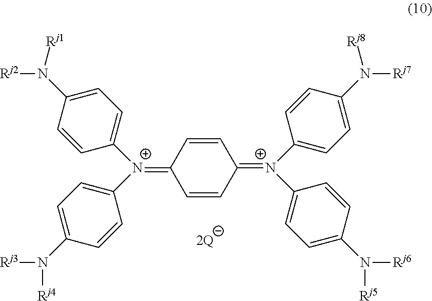

In Formula (10), R^{j1} to R^{j8} each independently represent an alkyl group which may have a substituent or an aromatic ring group which may have a substituent.

It is preferable that at least one of R^{j1} to R^{j8} represents an alkyl group having the specific substituent or an aromatic ring group having the specific substituent.

Q⁻ represents an anion, and examples thereof include halide ions, perchlorate ions, fluoroantimonate ions, fluorophosphate ions, fluoroborate ions, trifluoromethanesulfonate ions, bis(trifluoromethane)sulfonic acid imide ions, and naphthalene sulfonic acid ions.

The oxonol-based coloring agent is preferably a compound represented by Formula (11).

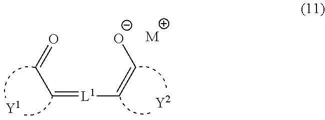

In Formula (11), Y¹ and Y² each independently represent an aliphatic ring or a non-metal atomic group forming a heterocyclic ring; M⁺ represents a proton, a monovalent alkali metal cation, or an organic cation; L¹ represents a methylene chain consisting of 5 or 7 methine groups, in which a methine group at a center of the methylene chain has a substituent represented by Formula (A) of *—S^{A}-T^{A}; in Formula (A), S^{A} represents a single bond, an alkylene group, an alkenylene group, an alkynylene group, —O—, —S—, —NR^{L1}—, —C(═O)—, —C(═O)O—, —C(═O)NR^{L1}—, —S(═O)₂—, —OR^{L2}—, or a group formed by a combination thereof; R^{L1} represents a hydrogen atom, a halogen atom, an alkyl group, an aryl group, or a heteroaryl group; R^{L2} represents an alkylene group, an arylene group, or a divalent heterocyclic group; T^{A} represents a halogen atom, an alkyl group, a cycloalkyl group, an aryl group, a heteroaryl group, a cyano group, a hydroxy group, a formyl group, a carboxy group, an amino group, a thiol group, a sulfo group, a phosphoryl group, a boryl group, a vinyl group, an ethynyl group, a trialkylsilyl group, or a trialkoxysilyl group; S^{A} represents a single bond or an alkylene group; in a case where T^{A} represents an alkyl group, the total number of carbon atoms included in S^{A} and T^{A} is 3 or more; and * represents a bonding site with the methine group at the center of the methylene chain.

The oxonol-based coloring agent is more preferably a compound represented by Formula (12).

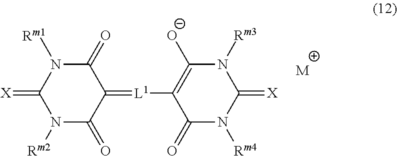

In Formula (12), M⁺ and L¹ are the same as M⁺ and L¹ in Formula (11).

R^{m1}, R^{m2}, R^{m3}, and R^{m4} each independently represent a hydrogen atom, an alkyl group, an aryl group, or a heteroaryl group; and X's each independently represent an oxygen atom, a sulfur atom, or a selenium atom.

The oxonol-based coloring agent is still more preferably a compound represented by Formula (13).

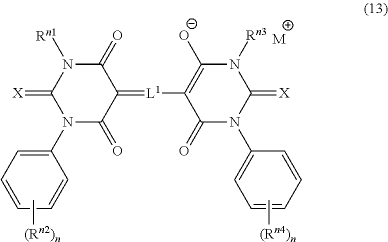

In Formula (13), M⁺, L¹, and X are the same as M⁺, L¹, and X in Formula (11).

Rⁿ¹ and Rⁿ³ each independently represent a hydrogen atom, an alkyl group, an aryl group, or a heteroaryl group; Rⁿ² and Rⁿ⁴ each independently represent an alkyl group, a halogen atom, an alkenyl group, an aryl group, a heteroaryl group, a nitro group, a cyano group, —OR^{L3}, —C(═O)R^{L3}, —C(═O)OR^{L3}, —OC(═O)R^{L3}, —N(R^{L3})₂, —NHC(═O)R^{L3}, —C(═O)N(R^{L3})₂, —NHC(═O)OR^{L3}, —OC(═O)N(R^{L3})₂, —NHC(═O)N(R^{L3})₂, —SR^{L3}, —S(═O)₂R^{L3}, —S(═O)₂OR^{L3}, —NHS(═O)₂R^{L3}, or —S(═O)₂N(R^{L3})₂; R^{L3}'s each independently represent a hydrogen atom, an alkyl group, an alkenyl group, an aryl group, or a heteroaryl group; and n's each independently represent an integer of 1 to 5.

In the present specification, the “rylene” refers to a compound having a molecular structure of a naphthalene unit bonded to a peri-position. Depending on the number of naphthalene units, the “rylene” may be, for example, perylene (n=2), terylene (n=3), quaterrylene (n=4), or higher rylene.

The rylene-based coloring agent is preferably a compound represented by Formula (14), a compound represented by Formula (15), or a compound represented by Formula (16).

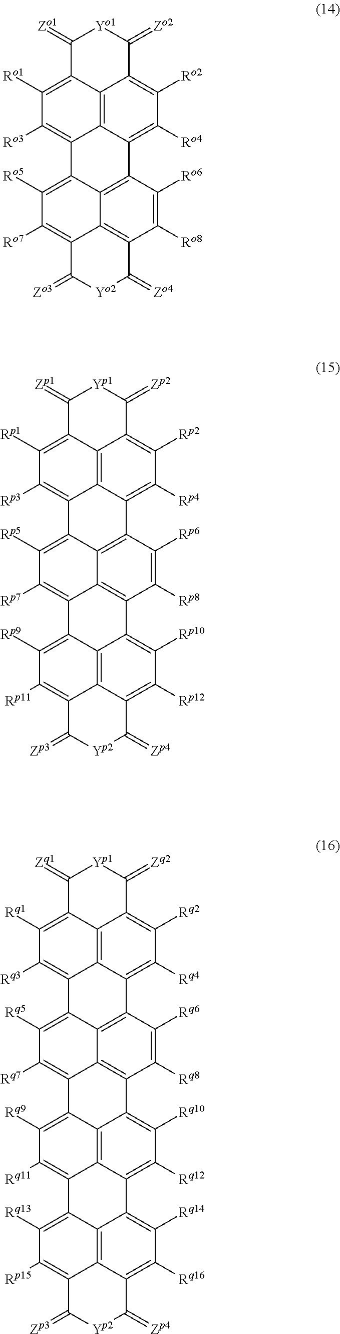

In Formula (14), Y^{o1} and Y^{o2} each independently represent an oxygen atom or —NR^{w1}—; R^{w1} represents a hydrogen atom or a substituent; Z^{o1} to Z^{o4} each independently represent an oxygen atom or —NR^{W2}—; R^{w2} represents a hydrogen atom or a substituent; R^{o1} to R^{o8} each independently represent a hydrogen atom or a substituent; and at least one of R^{o1} to R^{o8}, or R^{z} represents the specific substituent. R^{W1} and R^{W2} may be bonded to each other to form a ring which may have a substituent. In a case where the ring to be formed has two or more substituents, the substituents may be bonded to each other to form a ring (for example, an aromatic ring).

In Formula (15), Y^{p1} and Y^{p2} each independently represent an oxygen atom or —NR^{w3}—; R^{w3} represents a hydrogen atom or a substituent; Z^{p1} to Z^{p4} each independently represent an oxygen atom or —NR^{W4}—; R^{w4} represents a hydrogen atom or a substituent; R^{p1} to R^{p12} each independently represent a hydrogen atom or a substituent; and at least one of R^{p1} to R^{p12}, or R^{z} represents the specific substituent. R^{W3} and R^{W4} may be bonded to each other to form a ring which may have a substituent. In a case where the ring to be formed has two or more substituents, the substituents may be bonded to each other to form a ring (for example, an aromatic ring).

In Formula (16), Y^{q1} and Y^{q2} each independently represent an oxygen atom or —NR^{w5}—; R^{w5} represents a hydrogen atom or a substituent; Z^{q1} to Z^{q4} each independently represent an oxygen atom or —NR^{W6}—; R^{w6} represents a hydrogen atom or a substituent; R^{q1} to R^{q16} each independently represent a hydrogen atom or a substituent; and at least one of R^{q1} to R^{q16}, or R^{z} represents the specific substituent. R^{W5} and R^{W6} may be bonded to each other to form a ring which may have a substituent. In a case where the ring to be formed has two or more substituents, the substituents may be bonded to each other to form a ring (for example, an aromatic ring).

A content of the specific aggregate is not particularly limited, but is preferably 1% to 30% by mass and more preferably 3% to 15% by mass with respect to the total mass of the optically anisotropic film.

### (Salt)

The optically anisotropic film may contain a salt.

In a case where the plate-like compound has an acid group or a salt thereof, by containing a salt in the optically anisotropic film, planes in the plate-like compound are more likely to associate with each other, and column-like aggregates are likely to be formed.

The above-described salt does not include the above-described organic compound, the above-described specific aggregate, and the above-described liquid crystal compound. That is, the above-described salt is a compound different from the above-described organic compound, the above-described specific aggregate, and the above-described liquid crystal compound.

The salt is not particularly limited, and may be an inorganic salt or an organic salt, but from the viewpoint that the aligning properties of the specific aggregate in the optically anisotropic film are more excellent, an inorganic salt is preferable. Examples of the inorganic salt include an alkali metal salt, an alkaline earth metal salt, and a transition metal salt, and from the viewpoint that the aligning properties of the specific aggregate in the optically anisotropic film are more excellent, an alkali metal salt is preferable.

The alkali metal salt is a salt in which a cation is an alkali metal ion, and the alkali metal salt is preferably lithium ion or sodium ion, and more preferably lithium ion. That is, as the salt, a lithium salt or a sodium salt is preferable, and a lithium salt is more preferable.

Examples of the alkali metal salt include hydroxides of an alkali metal, such as lithium hydroxide, sodium hydroxide, and potassium hydroxide; carbonates of an alkali metal, such as lithium carbonate, sodium carbonate, and potassium carbonate; and bicarbonates of an alkali metal, such as lithium bicarbonate, sodium bicarbonate, and potassium bicarbonate.

In addition to the above, examples of the alkali metal salt include a phosphate and a chloride.

Examples of an anion of the above-described salt include a hydroxide ion, a carbonate ion, a chloride ion, a sulfate ion, a nitrate ion, a phosphate ion, a borate ion, a tetrafluoroborate ion, a hexafluorophosphate ion, a perchlorate ion, a toluenesulfonate ion, an oxalate ion, a formate ion, a trifluoroacetate ion, a trifluoromethanesulfonate ion, a bis(fluoromethanesulfonyl)imide ion, a bis(pentafluoroethanesulfonyl)imide ion, and a bis(trifluoromethanesulfonyl)imide ion.

In a case where the plate-like compound has a salt of an acid group, it is preferable that the cation in the salt of an acid group and the cation in the salt used are of the same type.

### <Properties of Optically Anisotropic Film>

The optically anisotropic film has no absorption in a visible light region.

Specifically, an average transmittance in a wavelength range of 400 to 700 nm is 90% or more, preferably 95% or more. The upper limit thereof may be less than 100%.

The above-described average transmittance can be measured by the same method as in the average transmittance of the liquid crystal compound.

The optically anisotropic film preferably has absorption in an infrared region.

The optically anisotropic film preferably has a maximal absorption wavelength in a wavelength range of 700 to 2,500 nm. Since the optically anisotropic film has the maximal absorption wavelength in the above-described range, the optically anisotropic film can absorb near-infrared rays in the wavelength range of 700 to 2,500 nm.

As described above, the above-described maximal absorption wavelength of the optically anisotropic film preferably corresponds to the maximal absorption wavelength of the specific aggregate contained in the optically anisotropic film.

An angle between a slow axis of the optically anisotropic film at a wavelength of 550 nm and a direction in which the absorption of the optically anisotropic film at a maximal absorption wavelength in the infrared region is largest is preferably 0° to 10° or 80° to 100°, and more preferably 0° to 5° or 85° to 95°.

The above-described angle can be measured by the following method.

The slow axis of the above-described optically anisotropic film at a wavelength of 550 nm can be measured using AxoScan manufactured by Axometrics, Inc. In addition, a direction in which the absorption of the optically anisotropic film is largest at a maximal absorption wavelength in an infrared region is determined by measuring an absorption spectrum while rotating the sample at 5° intervals using an ultraviolet-visible-near infrared spectrophotometer V-660 including an automatic absolute reflectivity measuring unit ARMN-735 manufactured by Jasco Corporation, and defined as a direction in which the absorbance is largest. The angle between the above-described slow axis and the above-described direction in which the absorbance is largest can be obtained.

The optically anisotropic film preferably has an absorption axis in an in-plane direction at a maximal absorption wavelength of the optically anisotropic film in the infrared region. Such an aspect can be achieved by aligning the specific aggregate having an absorption corresponding to the above-described maximal absorption wavelength.

An alignment degree of the optically anisotropic film is not particularly limited, but from the viewpoint that the absorption characteristics of the optically anisotropic film are more excellent, it is preferably 0.60 or more, more preferably 0.80 or more, and still more preferably 0.90 or more. The upper limit thereof is not particularly limited, but may be 1.00 or less.

The above-described alignment degree is an alignment degree measured by a maximal absorption wavelength of the optically anisotropic film in an infrared region, and corresponds to an alignment degree measured by a maximal absorption wavelength of the specific aggregate. In a case where the specific aggregate in the optically anisotropic film forms a J-aggregate, the alignment degree is determined using the maximal absorption wavelength derived from the J-aggregate of the specific aggregate.

Specifically, the alignment degree is calculated by the following method.

Using an ultraviolet-visible-near infrared spectrophotometer V-660 including an automatic absolute reflectivity measuring unit ARMN-735 manufactured by Jasco Corporation, the absorbance of the optically anisotropic film is measured to calculate the alignment degree from the following expression. Polarized light used is polarized light at a maximal absorption wavelength of the optically anisotropic film in an infrared region.

Alignment degree: S=[(Az0/Ay0)−1]/[(Az0/Ay0)+2]

Az0: absorbance of optically anisotropic film with respect to polarized light in absorption axis direction

Ay0: absorbance of optically anisotropic film with respect to polarized light in transmission axis direction

A dichroic ratio of the optically anisotropic film is preferably 0 or more, more preferably 10 or more, and still more preferably 30 or more. The upper limit thereof may be 100 or less.

The above-described dichroic ratio can be calculated by measuring Az0 and Ay0 in the same manner as the above-described alignment degree and using the following expression.

Dichroic ratio=Az0/Ay0

A film thickness of the optically anisotropic film is preferably 10 μm or less, more preferably 0.5 to 8.0 μm, and still more preferably 0.5 to 6.0 μm.

The film thickness of the optically anisotropic film is an average value obtained by measuring any 10 films of the optically anisotropic film using ultra-high resolution non-contact 3D surface profile measurement system BW-A501 manufactured by Nikon Corporation, and arithmetically averaging the obtained values.

### <Method for Manufacturing Optically Anisotropic Film>

A method for manufacturing the optically anisotropic film according to the embodiment of the present invention is not particularly limited, and for example, a method including a step of applying a composition containing the above-described components to align the liquid crystal compound and the specific aggregate in the coating film to form the optically anisotropic film is preferable.

Hereinafter, the procedure of the above-described method will be described in detail.

The composition used in the above-described method contains the liquid crystal compound, and the organic compound or the specific aggregate. The content of each component is adjusted to be the content of each component in the above-described optically anisotropic film.

The composition may contain a solvent.

The type of the solvent is not particularly limited, but an aqueous medium is preferable.

The aqueous medium is water or a mixed solution of water and a water-soluble organic solvent.

The water-soluble organic solvent is a solvent having a solubility in water of 5% by mass or more at 20° C. Examples of the water-soluble organic solvent include alcohol compounds, ketone compounds, ether compounds, amide compounds, nitrile compounds, and sulfone compounds.

A concentration of solid contents of the composition is not particularly limited, but from the viewpoint that the effect of the present invention is more excellent, it is preferably 1% to 50% by mass and more preferably 3% to 30% by mass with respect to the total mass of the composition.

A content of the liquid crystal compound in the composition is not particularly limited, but is preferably 60% to 99% by mass and more preferably 80% to 97% by mass with respect to the total solid content in the composition.

A content of the organic compound or the specific aggregate in the composition is not particularly limited, but is preferably 2% to 20% by mass and more preferably 5% to 10% by mass with respect to the total solid content in the composition.

The total solid content means components capable of forming the optically anisotropic film, excluding a solvent. In a case where the property of the above-described component is in a liquid state, it is counted as the solid content.

A method of applying the composition is not particularly limited, and usually, the composition is applied onto a support.

A support to be used is a member having a function as a base material for applying the composition. The support may be a so-called temporary support.

Examples of the support (temporary support) include a plastic substrate and a glass substrate. Examples of a material constituting the plastic substrate include a polyester resin such as polyethylene terephthalate, a polycarbonate resin, a (meth)acrylic resin, an epoxy resin, a polyurethane resin, a polyamide resin, a polyolefin resin, a cellulose resin, a silicone resin, and polyvinyl alcohol.

A thickness of the support may be 5 to 1,000 μm, preferably 10 to 250 μm and more preferably 15 to 90 μm.

As necessary, an alignment film may be disposed on the support.

The alignment film generally contains a polymer as a main component. The polymer for the alignment film is described in a large number of documents, and a large number of commercially available polymer products are available. The polymer for the alignment film is preferably a polyvinyl alcohol, a polyimide, a derivative thereof, an azo derivative, or a cinnamoyl derivative.

It is preferable that the alignment film is subjected to a known rubbing treatment.

In addition, a photo-alignment film may be used as the alignment film.

A thickness of the alignment film is preferably 0.01 to 10 μm and more preferably 0.01 to 1 μm.

The application method may be, for example, a known method, examples thereof include a curtain coating method, an extrusion coating method, a roll coating method, a dip coating method, a spin coating method, a print coating method, a spray coating method, and a slide coating method.

In addition, in a case where the composition is a lyotropic liquid crystalline composition, by adopting a coating method of applying shearing to the composition, such as wire bar coating, it is possible to simultaneously perform two treatments of application and alignment of various compounds. That is, by subjecting the composition to a shearing treatment, it is possible to align the liquid crystal compound and the specific aggregate.

In addition, the liquid crystal compound may be continuously aligned at the same time as the continuous application. Examples of the continuous application include a curtain coating method, an extrusion coating method, a roll coating method, and a slide coating method.

A method of aligning each compound in the applied composition is not particularly limited, and a known method is adopted.

For example, in a case where the composition contains the lyotropic liquid crystal compound, examples thereof include a method of applying shearing as described above.

In a case where the composition contains the lyotropic liquid crystal compound, examples of another method for aligning each compound in the applied composition include a method of using an alignment film as described above.

An alignment direction can be controlled by subjecting the alignment film to an alignment treatment in advance in a predetermined direction. In particular, the method of using an alignment film is preferable in a case where continuous application is carried out using a roll-like support so that the compound is aligned in a direction oblique to a transport direction.

In the method of using an alignment film, a concentration of the solvent in the composition used is not particularly limited, and may be a concentration such that the composition exhibits lyotropic liquid crystallinity, or may be a concentration equal to or lower than the concentration. In a case where the composition is a lyotropic liquid crystalline composition, even in a case where the concentration of the solvent in the composition is high (a case where the composition itself exhibits an isotropic phase), in the drying process after the application of the composition, lyotropic liquid crystallinity is expressed, which induces alignment of the compound on the alignment film, so that the optically anisotropic film can be formed.

In addition, in a case where the composition contains a thermotropic liquid crystal compound, a method of performing a heat treatment on the formed composition layer is used.

The method for manufacturing the optically anisotropic film according to the embodiment of the present invention may include steps other than the above-described steps.

It is preferable that the other steps further include a step of immobilizing the liquid crystal compound.

A method of fixing an alignment state of the liquid crystal compound is not particularly limited, and examples thereof include a method of heating and then cooling a coating film as described above.

In addition, in a case where at least one of the liquid crystal compound or the specific aggregate has an acid group or a salt thereof, examples of a method of fixing an alignment state of the liquid crystal compound include a method of bringing a solution containing a polyvalent metal ion into contact with the formed optically anisotropic film. By bringing the solution containing a polyvalent metal ion into contact with the formed optically anisotropic film, the polyvalent metal ion is supplied into the optically anisotropic film. The polyvalent metal ion supplied into the optically anisotropic film serves as a crosslinking point between the acid groups or the salts thereof contained in the liquid crystal compound, a crosslinking structure is formed in the optically anisotropic film, and the alignment state of the liquid crystal compound is fixed.

The type of the polyvalent metal ion used is not particularly limited, but from the viewpoint that the alignment state of the liquid crystal compound and/or the specific aggregate is easily fixed, an alkaline earth metal ion is preferable, and a calcium ion is more preferable.

In addition, the method for manufacturing the optically anisotropic film according to the embodiment of the present invention has been described using a composition containing a liquid crystal compound, but a method other than the above may be used.

Examples of another aspect of the method for manufacturing the optically anisotropic film according to the embodiment of the present invention include a method of forming a un-stretched film containing the specific aggregate and the polymer, and stretching and aligning the obtained un-stretched film to form an optically anisotropic film which is a stretching film.

Examples of a method of forming the un-stretched film include a method of applying a composition containing the specific aggregate or an organic compound capable of forming the aggregate, a polymer, and a solvent to form the un-stretched film, and a method of forming the un-stretched film by melting and forming a solid content containing the specific aggregate or an organic compound capable of forming the aggregate, and the polymer, without using a solvent.

Examples of the stretching method include known methods such as longitudinal uniaxial stretching, horizontal uniaxial stretching, or a combination thereof such as simultaneous biaxial stretching or sequential biaxial stretching.

The specific aggregate or the organic compound capable of forming the aggregate, used in the production of the above-described stretching film, is as described above.

Examples of the polymer used in the production of the above-described stretching film include the above-described polymers.

By changing stretching conditions of the stretching film and the material used, various characteristics (for example, the average transmittance and the alignment degree) of the optically anisotropic film described above can be appropriately adjusted.

### <Applications>

The optically anisotropic film according to the embodiment of the present invention can be applied to various applications.

For example, the optically anisotropic film according to the embodiment of the present invention can be used as a retardation film. In particular, the optically anisotropic film according to the embodiment of the present invention can be used as an infrared ray retardation film which can absorb any wavelength in a wavelength range of 700 to 2,500 nm.

In addition, the optically anisotropic film according to the embodiment of the present invention may be used in combination with other members.

For example, a protective film may be disposed on one surface or both surfaces of the optically anisotropic film according to the embodiment of the present invention. In a case where the protective film is disposed, it may be disposed through an adhesive or a pressure sensitive adhesive.

Examples of the protective film include a triacetyl cellulose film, an acrylic film, a polycarbonate film, and a cycloolefin film. As the protective film, a film which is transparent, has a small amount of birefringence, and hardly causes a phase difference is preferable.

In addition, the optically anisotropic film according to the embodiment of the present invention may be combined with other layers such as a hard coat layer, an antiglare layer, and an antireflection layer. These other layers may be disposed through an adhesive or a pressure sensitive adhesive.

The optically anisotropic film according to the embodiment of the present invention can also be used by being bonded to an inorganic substrate such as a prism and glass, a plastic plate, or the like. In a case where the inorganic substrate or the plastic substrate has a curved surface, a curved surface can also be formed by bonding the optically anisotropic film according to the embodiment of the present invention to the curved surface.

The optically anisotropic film according to the embodiment of the present invention may be combined with various functional layers for improving a viewing angle, various functional layers for improving contrast, a layer having brightness improving properties, and the like.

Examples of the above-described various functional layers include a layer which controls a phase difference.

The optically anisotropic film according to the embodiment of the present invention, which is combined with such various functional layers, can be applied to various display devices such as a liquid crystal display device.

In addition to the above, the optically anisotropic film according to the embodiment of the present invention can be applied to liquid crystal projectors, calculators, clocks, laptops, word processors, liquid crystal televisions, polarized lenses, polarized glasses, car navigation systems, sensors, lenses, switching elements, isolators, cameras, indoor and outdoor measuring instruments, and displays for cars.

Among these, the optically anisotropic film according to the embodiment of the present invention is suitably applied to a display device. That is, the present invention also relates to a display device including the optically anisotropic film according to the embodiment of the present invention. In addition, the optically anisotropic film according to the embodiment of the present invention is also suitably applied to a camera (particularly, a polarized multispectral camera) and a sensor.

In addition, the optically anisotropic film according to the embodiment of the present invention may be combined with an infrared light source. That is, the present invention also relates to a device including the optically anisotropic film according to the embodiment of the present invention and an infrared light source. Examples of such a device include a distance measurement device such as Light Detection and Ranging (LIDAR).

### EXAMPLES

Hereinafter, the features of the present invention will be more specifically described using Examples and Comparative Examples. The materials, the amounts and proportions of the materials used, the details of treatments, the procedure of treatments, and the like shown in Examples can be appropriately modified as long as the gist of the present invention is maintained. The scope of the present invention is not construed as being limited by the following specific examples.

### <Organic Compound>

Compounds A1 to A5 were synthesized by a known method. All of the compounds A1 to A5 are dichroic coloring agents. The compound A3 is D-1 described in WO2020/175448A.

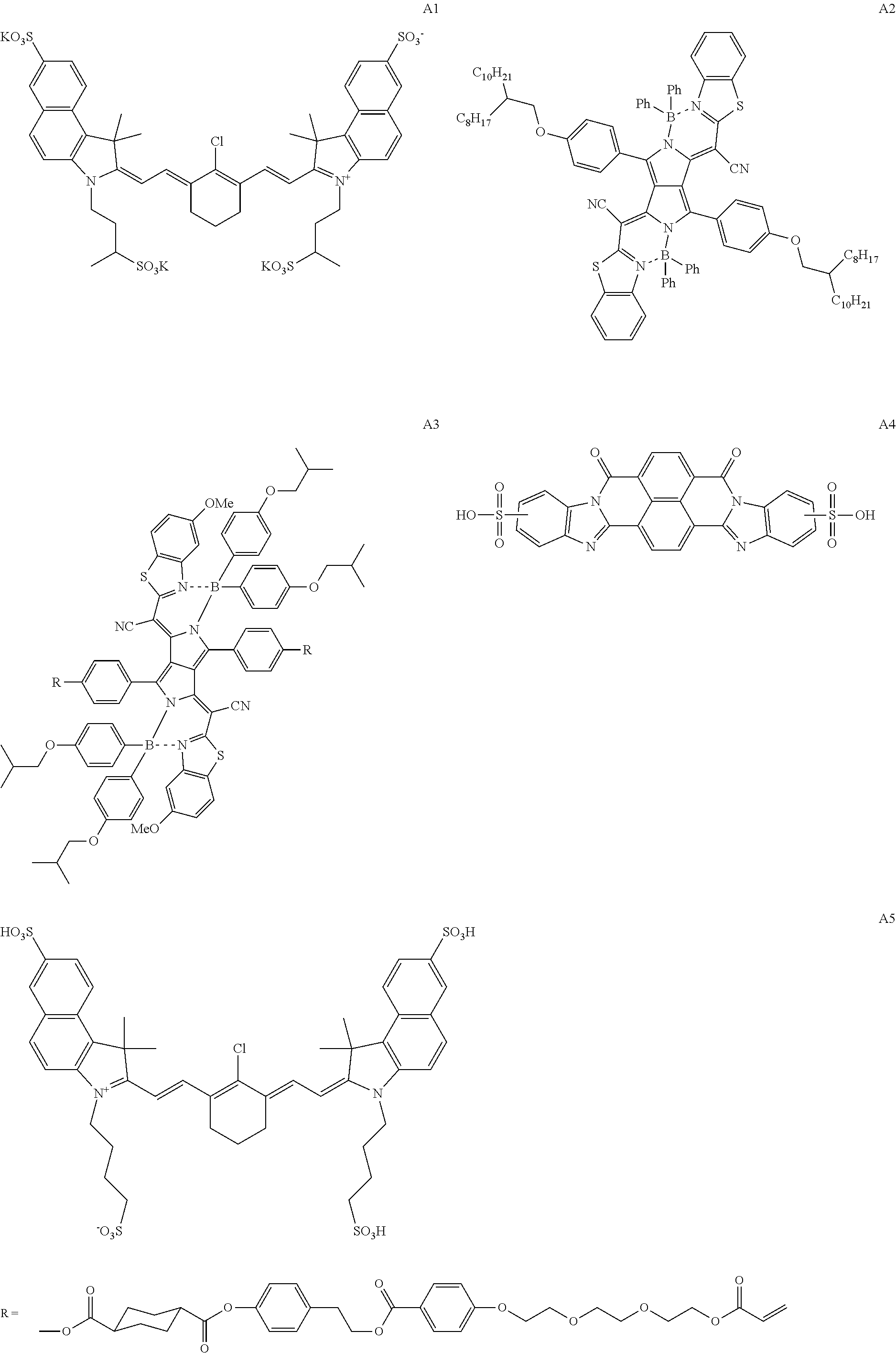

### <Liquid Crystal Compound>

Both liquid crystal compounds B1 and B2 exhibited lyotropic liquid crystallinity, and all liquid crystal compounds B3 to B5 exhibited thermotropic liquid crystallinity.

In addition, all of the liquid crystal compounds B1 to B5 did not have absorption in the visible light region.

The liquid crystal compound B1 was a liquid crystal polymer (in the formula, n is 2 or more), and had a number-average molecular weight of 25,000 and a molecular weight distribution of 5.1.

The liquid crystal compound B3 had a number-average molecular weight of 9,000 and a molecular weight distribution of 1.9.

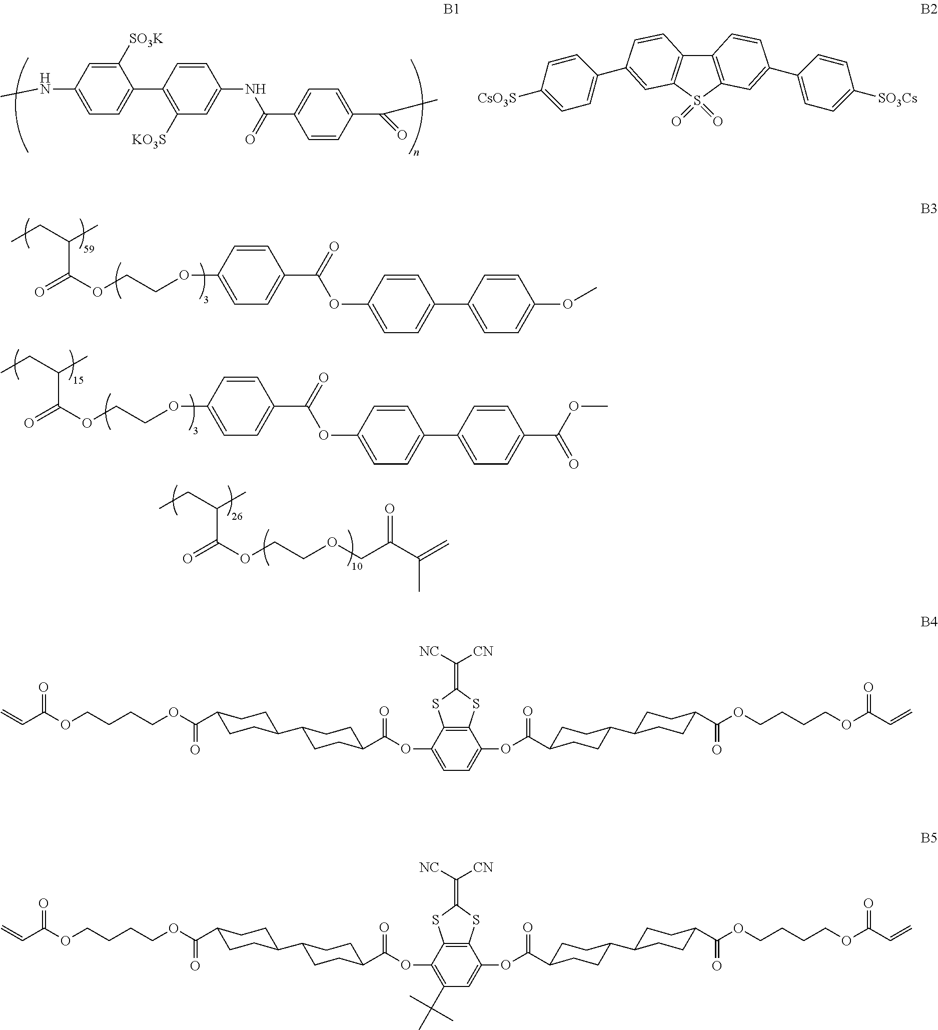

### Example 1

A composition 1 having the following composition was prepared.

### Composition 1

| | | |
|---|---|---|
| Liquid crystal compound (plate-like compound) B | 10 | parts by mass |
| Organic compound (dichroic coloring agent) A1 | 0.5 | parts by mass |
| Water | 89.5 | parts by mass |

The composition 1 prepared above was applied onto a glass substrate as a base material with a wire bar (moving speed: 100 cm/s), and naturally dried.

Next, the obtained composition layer was immersed in a 1 mol/L calcium chloride aqueous solution for 5 seconds, washed with ion exchange water, and blast-dried to fix the alignment state, thereby producing an optically anisotropic film 1 having a film thickness of 1.2 μm.

The film thickness was measured by the above-described method using ultra-high resolution non-contact 3D surface profile measurement system BW-A501 manufactured by Nikon Corporation.

### Example 2 and Comparative Example 2

Optically anisotropic films 2 and 6, having a film thickness of 1.2 μm, were produced by the same method as in Example 1, except that the compound was changed to compounds shown in Table 1 below.

### Example 3

### (Production of Transparent Support)

### —Production of Core Layer Cellulose Acylate Dope—

The following composition was put into a mixing tank and stirred to dissolve each component, thereby preparing a cellulose acetate solution used as a core layer cellulose acylate dope.

Core layer cellulose acylate dope

| | | |
|---|---|---|
| Cellulose acetate having acetyl substitution degree | 100 | parts by mass |
| of 2.88 | | |
| Polyester compound B described in Examples of | 12 | parts by mass |
| JP2015-227955A | | |
| Compound F | 2 | parts by mass |
| Methylene chloride (first solvent) | 430 | parts by mass |
| Methanol (second solvent) | 64 | parts by mass |

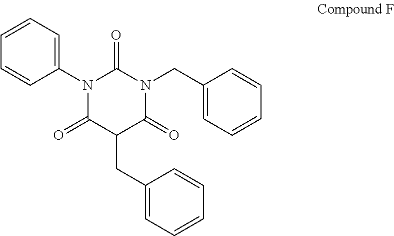 [SMILES: O=C1C(Cc2ccccc2)C(=O)N(c2ccccc2)C(=O)N1Cc1ccccc1]

### —Production of Outer Layer Cellulose Acylate Dope—

10 parts by mass of the following matte agent solution was added to 90 parts by mass of the core layer cellulose acylate dope to prepare a cellulose acetate solution to be used as an outer layer cellulose acylate dope.

Matting agent solution

| | | |
|---|---|---|
| Silica particles with average particle size of 20 nm | 2 | parts by mass |
| (AEROSIL R972, manufactured by Nippon Aerosil | | |
| Co., Ltd.) | | |
| Methylene chloride (first solvent) | 76 | parts by mass |
| Methanol (second solvent) | 11 | parts by mass |
| Core layer cellulose acylate dope described above | 1 | part by mass |

### —Production of Cellulose Acylate Film 1—

The core layer cellulose acylate dope and the outer layer cellulose acylate dope were filtered through filter paper having an average hole diameter of 34 μm and a sintered metal filter having an average pore size of 10 μm, and three layers which were the core layer cellulose acylate dope and the outer layer cellulose acylate dopes provided on both sides of the core layer cellulose acylate dope were simultaneously cast from a casting port onto a drum at 20° C. (band casting machine).

Next, the film was peeled off in a state where the solvent content was approximately 20% by mass, both ends of the film in the width direction were fixed by tenter clips, and the film was dried while being stretched at a stretching ratio of 1.1 times in the lateral direction.

Thereafter, the film was further dried by being transported between the rolls of the heat treatment device to produce an optical film (transparent support) having a thickness of 40 μm, and the optical film was used as a cellulose acylate film 1. An in-plane retardation (wavelength: 550 nm) of the obtained cellulose acylate film 1 was 0 nm.

### (Formation of Photo-Alignment Film)

The cellulose acylate film 1 was continuously coated with a coating liquid PA1 for forming a photo-alignment film described below with a wire bar. The support on which the coating film had been formed was dried with hot air at 140° C. for 120 seconds, and the coating film was irradiated with polarized ultraviolet rays (10 mJ/cm², using an ultra-high pressure mercury lamp) to form a photo-alignment film PA1, thereby obtaining a triacetyl cellulose (TAC) film with the photo-alignment film. A film thickness of the photo-alignment film PA1 was 0.5 μm.

Coating liquid PA1 for forming photo-alignment film

| | | |
|---|---|---|
| Polymer PA-1 | 100.00 | parts by mass |
| Acid generator PAG-1 | 8.25 | parts by mass |
| Stabilizer DIPEA | 0.6 | parts by mass |
| Xylene | 1126.60 | parts by mass |
| Methyl isobutyl ketone | 125.18 | parts by mass |

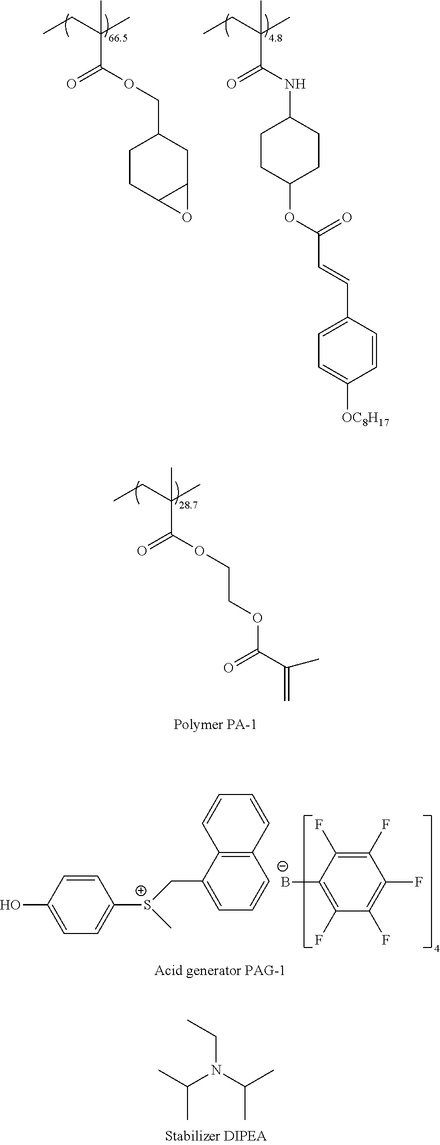

### (Production of Optically Absorption Anisotropic Film 3)

A coating layer was formed by continuously coating the obtained photo-alignment film PA1 with a composition for forming an optically anisotropic film, having the following composition, with a wire bar.

Next, the coating layer was heated at 140° C. for 15 seconds, and the coating layer was cooled to room temperature (23° C.).

Next, the coating layer was heated at 80° C. for 60 seconds and cooled to room temperature again.

Thereafter, the coating layer was irradiated with an LED lamp (central wavelength of 365 nm) for 2 seconds under an irradiation condition of an illuminance of 200 mW/cm², thereby producing an optically anisotropic film 3 on the photo-alignment film PA1. A film thickness of the optically anisotropic film 3 was 2.0 μm.

Composition for forming optically anisotropic film

| | | |
|---|---|---|
| Organic compound (dichroic coloring agent) A2 | 0.38 | parts by mass |
| Liquid crystal compound B3 | 2.67 | parts by mass |
| Polymerization initiator | 0.17 | parts by mass |
| IRGACURE OXE-02 (manufactured by BASF) | | |
| Surfactant F-1 shown below | 0.020 | parts by mass |
| Cyclopentanone | 91.95 | parts by mass |
| Benzyl alcohol | 2.36 | parts by mass |

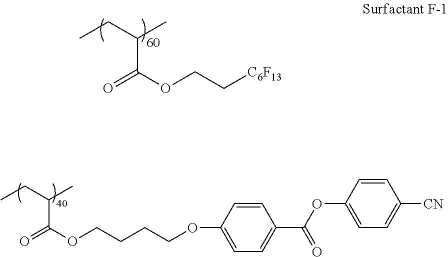

### (Formation of Oxygen-Shielding Layer B1)

The optically anisotropic film 3 was continuously coated with a coating liquid B1 having the following composition with a wire bar. Thereafter, the coating layer was dried with hot air at 80° C. for 5 minutes, and irradiated with ultraviolet rays (300 mJ/cm², using an ultra-high pressure mercury lamp), thereby obtaining a laminate A on which an oxygen-shielding layer B1 consisting of polyvinyl alcohol (PVA) with a thickness of 1.0 μm was formed, that is, a laminate including the cellulose acylate film 1 (transparent support), the photo-alignment film PA1, the optically anisotropic film 3, and the oxygen-shielding layer B1 adjacent to each other in this order.

Composition of coating liquid B1 for
forming oxygen-shielding layer

| | | |
|---|---|---|
| Modified polyvinyl alcohol shown below | 3.80 | parts by mass |
| Initiator IRGACURE 2959 | 0.20 | parts by mass |
| Water | 70 | parts by mass |
| Methanol | 30 | parts by mass |

### Modified Polyvinyl Alcohol

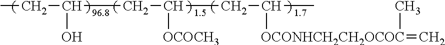

### Example 4

A laminate including an optically anisotropic film 4 was produced according to the same procedure as in Example 3, except that the organic compound (dichroic coloring agent) A2 was changed to an organic compound (dichroic coloring agent) A3.

### Comparative Example 1

### (Composition of Coating Liquid)

Composition of coating liquid

| | | |
|---|---|---|
| Liquid crystal compound B3 | 50 | parts by mass |
| Liquid crystal compound B4 | 50 | parts by mass |
| Organic compound (dichroic coloring agent) A3 | 5 | parts by mass |
| Photopolymerization initiator PI-1 | 0.50 | parts by mass |
| Fluorine-containing compound F-1 | 0.20 | parts by mass |
| Chloroform | 560 | parts by mass |

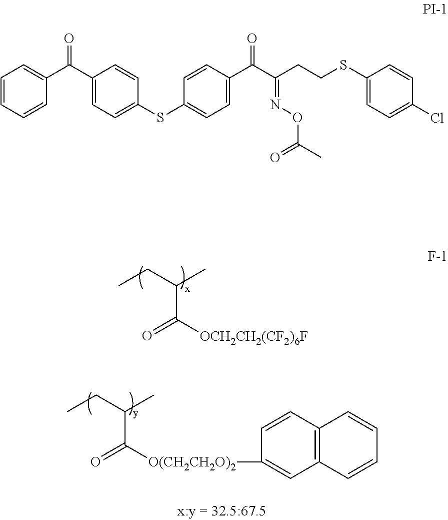

### (Film Forming Method)

The above-described coating liquid was applied onto a glass substrate with a polyimide alignment layer (SE-130, manufactured by Nissan Chemical Corporation), which had been subjected to a rubbing treatment, by spin-coating to form a coating film, and the coating film was heated at 210° C. for 1 minute and then rapidly cooled to 100° C. Thereafter, nitrogen purge was performed so as to create an atmosphere with an oxygen concentration of 1.0% by volume or less, and the coating film was irradiated with ultraviolet rays at an irradiation dose of 500 mJ/cm² using a high-pressure mercury lamp to produce an optically anisotropic film 5.

A 4% by mass aqueous solution of PVA103 (manufactured by Kuraray Co., Ltd.) was spin-coated on the optically anisotropic film 5 produced above, and heated at 100° C. for 2 minutes to form a polyvinyl alcohol (PVA) layer having a thickness of 1.0 μm on the optically anisotropic film 5, thereby obtaining a laminate including the optically anisotropic film 5 and the PVA layer.

An oxygen permeability of the PVA layer was 10 mL/m²·day·atm or less.

### Comparative Example 3

A polyvinyl alcohol film (VF-PS manufactured by Kuraray Co., Ltd.) having a saponification degree of 99% or more and an average degree of polymerization of 2,400 was immersed in warm water at 40° C. for 3 minutes to apply a swelling treatment and set the stretching ratio to 1.30 times. The swollen film was immersed in a staining solution at 45° C., which contained water (1,500 parts by mass), sodium tripolyphosphate (1.5 parts by mass), ammonium molybdate tetrahydrate (1.5 parts by mass), and the organic compound A5 (1.5 parts by mass), for 8 minutes and 00 seconds. The obtained film was immersed in a 40° C. aqueous solution containing 20 g/L of boric acid (manufactured by Societa Chmica Larderello S.p.a.) for 1 minute. The film after the immersion was stretched by 5.0 times for 5 minutes in a 50° C. aqueous solution containing 30.0 g/L of boric acid. The obtained film was subjected to a cleaning treatment by being immersed in water at 25° C. for 20 seconds while maintaining the tension state. The film after the cleaning was dried at 70° C. for 9 minutes. Thereafter, a protective film was provided by laminating an alkali-treated triacetyl cellulose film (TD-80U manufactured by FUJIFILM Corporation), using an adhesive obtained by dissolving 4% by mass of polyvinyl alcohol (NH-26 manufactured by JAPAN VAM & POVAL CO., LTD.) in water, thereby obtaining an optically anisotropic film 7.

All of the optically anisotropic films 1 to 4 had an absorption in an infrared region.

### <Evaluation>

### (Optical Properties)

For each of the optically anisotropic films 1 to 7, a dichroic ratio and an alignment degree were measured.

Using an ultraviolet-visible-near infrared spectrophotometer V-660 including an automatic absolute reflectivity measuring unit ARMN-735 manufactured by Jasco Corporation, the dichroic ratio and the alignment degree were calculated from the following expression with the absorbance of the optically anisotropic film.

As the polarized light used in the following measurement, polarized light having a maximal absorption wavelength of each optically anisotropic film in a wavelength range of 400 to 2,500 nm was used. The maximal absorption wavelength also corresponds to the maximal absorption wavelength of the J-aggregate of the specific aggregate in each optically anisotropic film.

$$Dichroic ratio = Az 0 / Ay 0 \\ Alignment degree = [ ( Az 0 / Ay 0 ) - 1 ] / [ ( Az 0 / Ay 0 ) + 2 ]$$

Az0: absorbance of optically anisotropic film with respect to polarized light in absorption axis direction

Ay0: absorbance of optically anisotropic film with respect to polarized light in transmission axis direction

The above-described absorption axis of the optically anisotropic film corresponds to an absorption axis of the optically anisotropic film at a maximal absorption wavelength in a wavelength range of 400 to 2,500 nm.

### (Specific Angle)

An angle (specific angle) between a slow axis of the optically anisotropic film at a wavelength of 550 nm and a direction in which the absorption of the optically anisotropic film at a maximal absorption wavelength in the infrared region was largest was measured by the following method.

The slow axis of the optically anisotropic film at a wavelength of 550 nm was measured using AxoScan manufactured by Axometrics, Inc., and the direction in which the absorption of the optically anisotropic film was largest at a maximal absorption wavelength in an infrared region was determined by measuring an absorption spectrum while rotating the sample at 5° intervals using an ultraviolet-visible-near infrared spectrophotometer V-660 including an automatic absolute reflectivity measuring unit ARMN-735 manufactured by Jasco Corporation, and defined as the direction in which the absorbance was largest. An angle between the obtained slow axis and the direction in which the absorbance was largest was obtained.

### (Average Length L and Average L/D)

For each optically anisotropic film, using image processing software “ImageJ”, an image obtained by binarizing a brightness of an SEM observation image of the surface of each optically anisotropic film acquired was created. Among the plurality of high-brightness regions of the created binarized image, a region having an area equal to or more than an area of a circle having a diameter of 50 nm (1963 nm²) was extracted as the specific aggregate. The binarization of the brightness of the surface SEM observation image was performed by creating a brightness histogram of the SEM observation image and extracting the brightness at which a frequency was the highest in the created brightness histogram, and a brightness 1.2 times the extracted brightness was used as a threshold value. Next, using the same software, each specific aggregate extracted was approximated to an ellipse, and a length of a major axis of the approximated ellipse was measured as the length L of the major axis of the specific aggregate, and a length of a minor axis of the approximated ellipse was measured as the length D of the minor axis of the specific aggregate. The measurement was performed at three locations in a 13.58 μm² region in which the measurements did not overlap with each other; D, L, and the ratio (L/D) of five specific aggregates are calculated at each location; and the calculated 15 L/D's were arithmetically averaged to calculate the average value (average L/D) of ratios described above, the calculated 15 L's were arithmetically averaged to calculate the average length L of the major axis, and the calculated 15 D's were arithmetically averaged to calculate the average length D of the minor axis.

### (λmax of Coloring Agent)

As a measuring method of the maximal absorption wavelength of the organic compounds (A1 to A5) used in each of Examples described above, using a solution prepared by dissolving the organic compound to be measured (5 to 50 mg) in a solution (for example, water, methanol, dimethyl sulfoxide, and the like) (1,000 mL) which dissolved the organic compound, an absorption spectrum was measured using a spectrophotometer (UV-3100PC (manufactured by Shimadzu Corporation)), and the maximal absorption wavelength was read from the obtained absorption spectrum.

### (Association State)

In the optically anisotropic films 1 to 5, the maximal absorption wavelength (J band) was observed on the long wavelength side with respect to the maximal absorption wavelength (λmax of the coloring agent) of the dichroic coloring agent used, and it was confirmed that the specific aggregate in the optically anisotropic films 1 to 5 was a J-aggregate.

Since the specific aggregate in the optically anisotropic film 6 was not observed in the J band, the optically anisotropic film 6 was an H-aggregate; and the optically anisotropic film 7 did not contain the specific aggregate.

Each of the optically anisotropic films had an absorption axis at a maximal absorption wavelength of each of the optically anisotropic films in a wavelength range of 400 to 2,500 nm in an in-plane direction.

(Waveform Separation of Peak Derived from J-Aggregate)

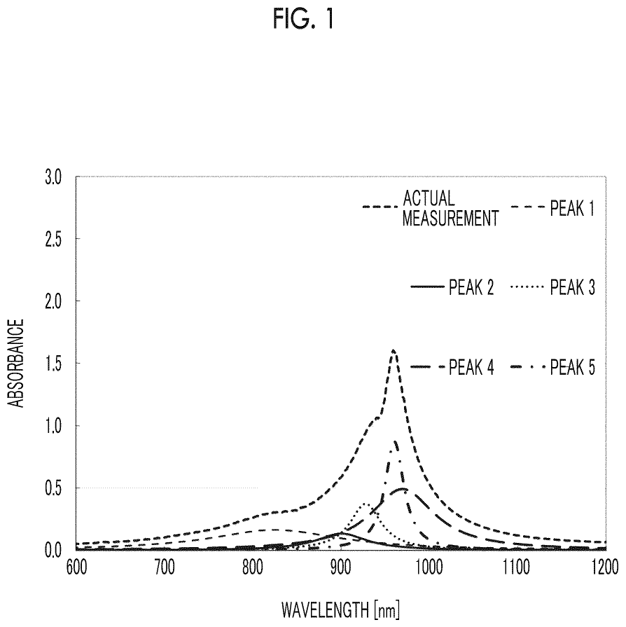

As an example, FIG. 1 shows an absorption spectrum in a case where the peak derived from the J-aggregate in the optically anisotropic film of Example 1 is subjected to waveform separation. In FIG. 1, the actual peak can be subjected to waveform separation into peaks 1 to 5, and the peak 1 corresponds to the absorption spectrum of the organic compound constituting the specific aggregate.

In a case where the absorption peak derived from the J-aggregate was standardized such that the absorbance at the maximal absorption wavelength (λmax) in the infrared region was 1.0, fitting by a linear combination of a Lorentz function was performed for a range in which the absorbance was 0.05 or more. The fitting was repeated until the number of Lorentz functions to be used was sequentially increased as a coefficient of determination R² of being 0.98 or more, in a case where the correlation analysis between the actually measured value and the simulation value was performed in 1 nm increments. Among the obtained plurality of peaks, the evaluation was performed in the following manner with respect to the number of Lorentz functions required for fitting by excluding the spectrum having the maximal absorption wavelength in a range of the maximal absorption wavelength (corresponding to the above-described maximal absorption wavelength of the λmax of the coloring agent)±10 nm in the infrared region of the organic compound constituting the specific aggregate. In a case of the following A evaluation, the absorption spectrum corresponds to an absorption spectrum composed of a plurality of peaks derived from the J-aggregate.

A: the number of Lorentz functions required for the fitting was 2 or more.

B: the number of the Lorentz functions required for the fitting was 1 or less.

### (Light Resistance)

In each optically anisotropic film, a surface of the optically anisotropic film on a side opposite to the substrate was set as an irradiation surface, each sample was set in a xenon irradiator (SX75 manufactured by Suga Test Instruments Co., Ltd.), and a test of irradiating the sample with a #275 filter for 200 hours was performed.

Re(550) of the optically anisotropic film before the test was measured and Re(550) of the optically anisotropic film after the test was measured, and light resistance was evaluated according to the following standard. The results are shown in Table 1 below. Re(550) represents an in-plane retardation of the optically anisotropic film at a wavelength of 550 nm. In addition, the amount of change in the following evaluation was calculated by the following expression.

$$Amount of change ( \% ) = \{ ( Re ( 550 ) before test - Re ( 550 ) after test ) / Re ( 550 ) before test \} \times 100$$

A: amount of change of Re(550) after the test with respect to Re(550) before the test was less than 5% of Re(550) before the test (amount of change obtained by the above expression was less than 5%)

B: amount of change of Re(550) after the test with respect to Re(550) before the test was 5% or more and less than 15% of Re(550) before the test (amount of change obtained by the above expression was 5% or more and less than 15%)

C: amount of change of Re(550) after the test with respect to Re(550) before the test was 15% or more of Re(550) before the test (amount of change obtained by the above expression was 15% or more)

### (Moisture-Heat Resistance)

With regard to test conditions for the moisture-heat resistance, a test in which an object was left to stand in an environment of 85° C. and a relative humidity of 85% for 500 hours was carried out.

A polarization degree of the optically anisotropic film before the test was measured and a polarization degree of the optically anisotropic film after the test was measured, and moisture-heat resistance was evaluated according to the following standard. The results are shown in Table 1 below. The amount of change in the following evaluation was calculated by the following expression.

$$Amount of change ( \% ) =$$

$$\{ ( Polarization degree before test - Polarization degree after test ) /$$

$$Polarization degree before test \} \times 100$$

A: amount of change of polarization degree after the test with respect to polarization degree before the test was less than 20%.

B: amount of change of polarization degree after the test with respect to polarization degree before the test was 20% or more and less than 60%.

C: amount of change of polarization degree after the test with respect to polarization degree before the test was 60% or more.

Using an ultraviolet-visible-near infrared spectrophotometer V-660 including an automatic absolute reflectivity measuring unit ARMN-735 manufactured by Jasco Corporation, the polarization degree was calculated from the following expression with the absorbance of the optically anisotropic film.

As the polarized light used in the measurement, polarized light having a maximal absorption wavelength of the optically anisotropic film in a wavelength range of 400 to 2,500 nm was used. The maximal absorption wavelength also corresponds to the maximal absorption wavelength of the J-aggregate composed of the dichroic coloring agent in each optically anisotropic film.

$$Polarization degree = [ Ty 0 - Tz 0 ] / [ Ty 0 + Tz 0 ]$$

Tz0: transmittance of optically anisotropic film with respect to polarized light in absorption axis direction

Ty0: transmittance of optically anisotropic film with respect to polarized light in transmission axis direction

The above-described absorption axis of the optically anisotropic film corresponds to an absorption axis of the optically anisotropic film at a maximal absorption wavelength in a wavelength range of 400 to 2,500 nm.

### (Visible Light Transparency)

For each optically anisotropic film, an average transmittance in a range of visible light region (wavelength: 400 to 700 nm) was measured using UV-3100PC (manufactured by Shimadzu Corporation).

A: average transmittance in a range of the visible light region (wavelength: 400 to 700 nm) was 90% or more.

B: average transmittance in a range of the visible light region (wavelength: 400 to 700 nm) was less than 90%.

In the table, the column “L” of “Specific aggregate” indicates the average length of the major axis of the specific aggregate.

The column “L/D” of “Specific aggregate” indicates the average aspect ratio of the specific aggregate.

The column “J peak waveform separation” indicates the evaluation result of the waveform separation of the peak derived from the J-aggregate described above.

The column “λmax” in the column of “Optically anisotropic film” indicates the maximal absorption wavelength of the optically anisotropic film.

The column “λmax of coloring agent” in the column of “Specific aggregate” indicates the maximal absorption wavelength exhibited by the solution obtained by dissolving the organic compound used in each of Examples.

TABLE 1

| | | | | | Specific aggregate | | | | | |
|---|---|---|---|---|---|---|---|---|---|---|
| | Optically anisotropic film | | | | | λmax of | | | | J peak |
| | | | Dichroic | Specific | Organic | coloring | | | Association | waveform |
| | Type | λmax | ratio | angle | compound | agent | L | L/D | state | separation |
| Example 1 | 1 | 940 | 41.0 | 0° | A1 | 850 | 2800 | 14 | J-aggregate | A |
| | | nm | | | | nm | nm | | | |
| Example 2 | 2 | 940 | 36.0 | 0° | A1 | 850 | 2500 | 12 | J-aggregate | A |
| | | nm | | | | nm | nm | | | |
| Example 3 | 3 | 860 | 31.0 | 0° | A2 | 810 | 220 | 3.5 | J-aggregate | A |
| | | nm | | | | nm | nm | | | |
| Example 4 | 4 | 870 | 34.0 | 90° | A3 | 800 | 270 | 3.5 | J-aggregate | A |
| | | nm | | | | nm | nm | | | |
| Comparative | 5 | 870 | 7.7 | 90° | A3 | 800 | 240 | 1.7 | J-aggregate | B |
| Example 1 | | nm | | | | nm | nm | | | |
| Comparative | 6 | 500 | 5.0 | 0° | A4 | 550 | 300 | 1.2 | H-aggregate | B |
| Example 2 | | nm | | | | nm | nm | | | |
| Comparative | 7 | 830 | 17.0 | 0° | A5 | 830 | — | — | Non- | B |
| Example 3 | | nm | | | | nm | | | aggregate | |

| | | | | Evaluation result | | | |
|---|---|---|---|---|---|---|---|
| | Liquid crystal | | | | | Moisture- | Visible |
| | compound | | | Alignment | Light | heat | light |
| | Type | | λmax | degree | resistance | resistance | transparency |
| Example 1 | B1 | Rod- | 290 | 0.93 | A | A | A |
| | | like | nm | | | | |
| Example 2 | B2 | Plate- | 345 | 0.92 | A | A | A |
| | | like | nm | | | | |
| Example 3 | B3 | Rod- | 270 | 0.91 | A | B | A |
| | | like | nm | | | | |
| Example 4 | B3 | Rod- | 270 | 0.92 | A | B | A |
| | | like | nm | | | | |
| Comparative | B4 + | — | — | 0.69 | A | B | A |
| Example 1 | B5 | | | | | | |
| Comparative | B2 | Plate- | 345 | 0.57 | C | A | B |
| Example 2 | | like | nm | | | | |
| Comparative | — | — | — | 0.84 | C | C | A |
| Example 3 | | | | | | | |

From the results shown in Table 1, it was found that the optically anisotropic film according to the embodiment of the present invention exhibited a desired effect.

It was found that, in a case where the length of the major axis of the specific aggregate was 500 nm or more (the average aspect ratio was 10 or more), the effect of the present invention was more excellent (Examples 1 to 4).

What is claimed is:

1. An optically anisotropic film comprising:
a liquid crystal compound or a polymer; and
an aggregate of organic compounds,
wherein the optically anisotropic film has no absorption in a visible light region,
an average value of ratios of lengths of major axes of the aggregate to lengths of minor axes of the aggregate is 2.0 or more, and
an average length of the minor axes of the aggregate is 10 nm or more.

2. The optically anisotropic film according to claim 1,
wherein the optically anisotropic film has an absorption in an infrared region.

3. The optically anisotropic film according to claim 2,
wherein a dichroic ratio in the infrared region is 10 or more.

4. The optically anisotropic film according to claim 2,
wherein an angle between a slow axis of the optically anisotropic film at a wavelength of 550 nm and a direction in which the absorption of the optically anisotropic film at a maximal absorption wavelength in the infrared region is largest is 0° to 10° or 80° to 100°.

5. The optically anisotropic film according to claim 1,
wherein the aggregate is a J-aggregate.

6. The optically anisotropic film according to claim 5,
wherein, in a case where an absorption spectrum of the aggregate in an infrared region is subjected to waveform separation, the absorption spectrum is composed of a plurality of peaks derived from the J-aggregate.

7. The optically anisotropic film according to claim 1,
wherein the optically anisotropic film contains the liquid crystal compound, and
the liquid crystal compound is lyotropic liquid crystalline.

8. A display device comprising:
the optically anisotropic film according to claim 1.
